(19) United States
(12) Patent Application Publication
(10) Pub. No.: US 2004/0133487 A1
(43) Pub. Date: Jul. 8, 2004

(54) Modular, convergent customer care and billing system

(75) Inventors: Mike Hanagan, Dusseldorf (DE); Leslee Eaton Cattrall Moore, Golden, CO (US); Daniel Rakic, Dusseldorf (DE); Andreas Seeger, Juchen (DE); Rene Sotola, Boulder, CO (US); Chris Tatem, Alexandria, VA (US)

Correspondence Address: STAAS & HALSEY LLP, SUITE 700, 1201 NEW YORK AVENUE, N.W., WASHINGTON, DC, 20005, US

(73) Assignee: American Management Systems, Inc., Fairfax, VA

(21) Appl. No.: 10/667,335

(22) Filed: Sep. 23, 2003

Related U.S. Application Data
(62) Division of application No. 09/353,629, filed on Jul. 15, 1999, now abandoned.
(60) Provisional application No. 60/094,459, filed on Jul. 29, 1998.

(51) Int. Cl. G06F 17/60

(52) U.S. Cl. 705/34

(57) ABSTRACT

A system that includes a set components that can offer a complete solution to a client or can be partitioned to offer solutions to specific areas. The components are modular. The components are independent and integrated containing all the necessary processes and inputs and outputs to function independently. The components can also be. integrated together into a system where the components work together. The set of components are also convergent by allowing all services to be provided and viewed via single interface through a single consolidated customer database independent of the type of service(s) being provided to a customer.

### CROSS REFERENCE TO RELATED APPLICATION

This application is a Divisional of U.S. application Ser. No. 09/335,629, filed Jul. 15, 1999 which is incorporated by reference herein.

This application is related to and claims priority to U.S. provisional application serial No. 60/094,459, filed Jul. 29, 1998, entitled Component Based-Object Oriented Convergent Customer Care And Billing System by Hohmann et. al. and which is incorporated herein by reference.

### BACKGROUND OF THE INVENTION

1. Field of the Invention

The present invention is directed to a customer care and billing system which is capable of providing billing related information to customers for all of a customers electronic transmissions and, more particularly, to a system of functionally complete components that can stand alone or be integrated together and which aggregates all of the telecommunication services, of a customer into a single genus of electronic transmissions having species associated with the type of electronic transmission, such as wireless.

2. Description of the Related Art

The telecommunications market has evolved significantly over the last 15 years. The two most significant differences are: deregulation and product availability.

Prior to 1984, the telecommunications industry was a government-regulated industry. The government regulated everything from the services a telecommunications provider could offer to the profit margin allowed for each service. Customer service was not important, because customers did not have an alternative. AT&T ruled the telecommunications industry.

In terms of availability, telecommunications was very simple. The concepts of wireless telephones, pagers, and the Internet were either not yet founded or founded but not available to the public.

Beginning in 1984, with the divestiture of AT&T, competition in telecommunications became available. Competitors used price as a differentiator, because profit margins were very high, and they could sacrifice some of this margin for the purposes of attracting more customers.

Today's market is completely different and continues to evolve. The successful provider for tomorrow's market will face full competition throughout the industry at every level. Today's Telecommunications Provider may offer: wireline, wireless, local, long distance, voice/data, cable, Internet access, entertainment, and potentially utilities such as electric or water. Government involvement is currently limited to only ensuring that competition is promoted, forcing incumbents to open up their markets. Competition has driven prices down to the point that competitor prices are very similar. Price is no longer a differentiator. Instead, customer service and billing options have become the primary differentiators in the marketplace.

In the past, customers typically received multiple bills for the different types of service they owned: wireline, wireless, pager, etc. This occurred because the company was setup to match the lines of business. The customer care and billing system for wireline service was completely separate from that for wireless service. In some cases, innovative providers added new processes to combine the end results of their separate billing streams, so that a customer could receive a single bill across these services. However, this process simply brought together the end result, preventing the provider from offering cross-service discounts.

The customer information was also maintained in separate systems, based on the line of business. Customer service representatives (CSRs) were assigned to a single system. Because of this, a single CSR could not see all of the customer's subscribed services. Customers with questions pertaining to services across business lines were handed from one CSR to another, resulting in dissatisfied customers.

To remain competitive, providers are forced to address customer needs immediately, including the ability to:

introduce new products quickly, sometimes in a matter of days;

provide a single customer view;

provide flexible bill formats that meet each customer's unique requirements;

bundle services so that multi-service price breaks are available;

combine charges from multiple customers or accounts for volume discounts; and

schedule service calls to meet the customer's schedule.

What is needed is the next generation Customer Care & Billing platform designed to meet tomorrow's needs of tomorrows providers Four terms stand out that define the needs of such a system.

Next generation—From a technical standpoint, what is needed is the use of technologies to enable maximum performance while enhancing inter-operability and modularity.

Customer Care & Billing platform—This term in the past has been loosely used to define any solution that addresses Customer Care and Billing to some degree. For the purposes of this discussion the definition is:

Customer Care: The process in which a Telecommunications Provider interacts with a customer on an ordering and provisioning, customer service and support, and financial basis. In the Telecommunications Industry, Customer Care is broken into many sub-processes including:

Customer Account Management

Service Order Processing

Billing

Customer service and inquiry support

Phone Number Inventory Management

Directory Assistance

Collections and Treatment Processing

Marketing

Commissions Management

Other customer/Telecommunications Provider interaction related processes.

Billing: As one large component of Customer Care, in the broadest sense, Billing provides for the not only a majority of the financial aspects of the Telecommunications Provider-customer relationship, but as a periodic communications mechanism that can support other interests such as marketing. As an independent process, billing provides for the collection, rating, tabulation and formatting of product data and respective charges to be distributed from a Telecommunications Provider to a customer. Sub-processes include:

Message (Call Detail Records) Collection and

Accounting

Usage Qualification, Processing, Rating, and Pricing

Taxing

Bill Calculation

Third Party Usage

Bill Formatting

Payments and Adjustments

Balance Management Account Management and

Maintenance

Bill Printing, Production, and Distribution (Mailing, Electronic Delivery, etc.)

Tomorrow's Needs—In the past, Telecommunications Providers provided a service in a non-competitive market; there was no need to provide high levels of customer service. As each market begins to open up to competition, it is no longer satisfactory to ignore the customer.

Telecommunications Providers need systems which help them reduce time to market (via a resilient, flexible product model), identify valuable customers (via customer historical information), meet customer requests (via flexible pricing and billing schemes), determine cost-effective marketing strategies (via demographics and preferences), and generate timely information (via on-demand pricing and billing).

In addition to telecommunications evolution, the market itself is evolving. The concept of global Telecommunications Providers are becoming a reality, spawning new requirements such as multiple language support, multiple currency support and conversion, and multiple format (e.g., dates) support. Outside forces also drive tomorrow's needs. Any viable solution must address the year 2000 and its implications to systems.

Tomorrow's Telecommunications Providers—Everyday, new alliances and takeovers occur. Tomorrow's Telecommunications Provider is not simply a telephone company, a cable company, an information provider, or an Internet provider, but a combination of some or all of these. Because of this, tomorrow's systems cannot be tailored towards any one specific industry but must be able to accommodate the nuances of each of the various industries in a single solution. The invention has been designed with this foresight in mind. No concentration on a single industry; no blinders to any industry. The focus is on a single, integrated solution that can be easily implemented by any Telecommunications Provider.

Due to the ever-evolving nature of telecommunications, the customer care and billing solutions must continue to evolve. The key concepts which need to be provided to differentiate from and improve over past and existing products are: convergence and modularity.

Convergence—Convergence enables a system to be the single customer care and billing system for any telecommunications provider. All services can be defined and offered to customers, regardless of line of business: wireline, wireless, Internet, cable, or entertainment. All services are maintained in a single customer database, proving a single customer view to CSRs. All of the services can be brought together into a single pricing plan to promote volume discounts across services. A single bill can be created which depicts all charges for these services, including cross-service discounting. The key here is that the bill is truly converged, not simply produced by consolidating the output of multiple systems (also known as “consolidated billing” or “electronic stapling”).

Modularity—Modularity allows a set of individual modules to be implemented individually or in combination. This modular approach needs to be taken to address provider need. Each provider will have unique requirements for a solution. Some will require a complete make-over, while others require update of only a portion of their existing processes. A modular design enables each component to be sold separately to meet each provider's needs. The cost of a large-scale customer care and billing system can be prohibitive to some providers.

### SUMMARY OF THE INVENTION

It is an object of the present invention to provide a customer care and billing system that is modular.

It is another object of the present invention to provide a system that is convergent.

The above objects can be attained by a system that includes a set components that can offer a complete solution to a client or can be partitioned to offer solutions to specific areas. The components are modular. The components are independent and integrated containing all the necessary processes and inputs and outputs to function independently. The components can also be integrated together into a system where the components work together. The set of components are also convergent by allowing all services to be provided and viewed via a single interface through a single consolidated customer database independent of the type of service(s) being provided to a customer.

These together with other objects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 depicts the components of the system of the present invention.

FIGS. 2-5 illustrate various component combinations.

FIG. 6 illustrates convergence.

FIGS. 7-9 depict object models.

FIG. 10 shows customer care manager functions.

FIGS. 11 and 12 show interface screens.

FIG. 13 illustrates product and service manager functions.

FIGS. 14 and 15 illustrate interface screens.

FIG. 16 shows event rater and pricer function.

FIG. 17 depicts ERP processes.

FIG. 18 illustrates customer billing manager functions.

FIG. 19 depicts CBM processes.

FIGS. 20 and 21 show interface screens.

FIG. 23 illustrates software layers.

FIG. 24 shows software organization.

FIG. 25 depicts on-line processing framework.

FIG. 26 illustrates a sample object.

FIG. 27 depicts batch architecture.

FIG. 28 shows the major types of inter-process and data access communications that occur within the invention.

FIG. 29 illustrates a data maintenance and access mechanism.

### DESCRIPTION OF THE PREFERRED EMBODIMENTS

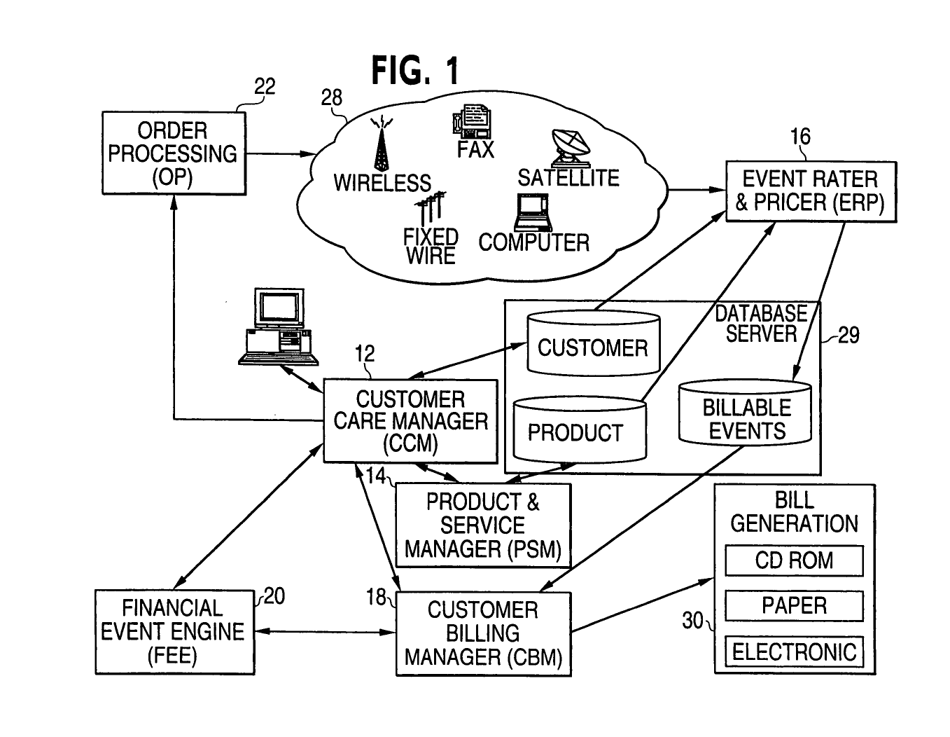

The present invention includes a set of components that can offer a complete solution to a client or can be partitioned to offer solutions to specific areas. As depicted in FIG. 1, a typical system 10 of the present invention preferably comprises several components. 12, 14, 16, 18, 20, and 22, as discussed in more detail below, which interact with network elements 28, a database server 29 and a bill generation system 30. Of course, additional components can be added in the future. This section provides a high level overview of each component in the Customer Care and Billing solution of the invention. Detailed descriptions and further details of each component can be found later herein.

Customer Care Manager (CCM) 12 provides proactive customer support. CCM 12 provides a flexible graphical user interface (GUI) customer service front-end system to use during customer acquisition, customer establishment, and customer maintenance. Its enhanced functionality provides both standard and advanced customer care functions. CCM 12 provides a complete view of a customer's products and discount plans across markets. CCM 12 interacts with external organizations (for instance, credit checking), providing advanced features to additionally support scripting and validations. With CCM's user interface, customer service representatives can spend more time focusing on the customer and less time on manual and redundant tasks. New products, new customer types, and new customer care management strategies can be quickly implemented, thereby reducing the time to market for such changes. Customer specific information in the invention is extensive, and goes well beyond that of traditional Customer Care & Billing systems. Examples of customer specific information are as follows: name, address, roles (e.g., invoice recipient, invoice payer, guarantor, legal entity), customer hierarchies, contacts, accounts, account hierarchies, service numbers, demographic information, preferences—such as language, geographic information, marketing information, internal and external credit scores, credit class, subscribed products, invoice formats, statement formats, bill messages, contracts, and guiding information—identifies the invoice and account on which each individual charge should appear. In addition to providing maintenance of this information, CCM 12 provides a forecasting mechanism which recommends products and price plans for customers.

The Products and Service Manager (PSM) 14 supports both the maintenance of reference data for products, services, and price plans. PSM 14 provides a graphical user interface that allows the user to rapidly define new products, services, and price plans, and easily maintain the existing reference data. PSM 14 offers a substantially reduced time-to-market for new products, services and price plans. A salable item is defined as either a product or a package, where a package is a combination of products and/or packages. The package concept allows Telecommunications Providers to bundle services in a manner that suits their needs. PSM 14 does not limit functionality based on product, as all products are defined in a similar manner. Because of this, wireless and wire-line products can be combined into a single package.

The Event Rater and Pricer (ERP) 16 provides convergent near real-time message processing functionality for usage and non-usage events. The rating is considered near real-time since it is performed as soon as the batch file with events is received from the network elements 28. Possible examples of a network element 28 are a switch, a router or another service system. ERP 16 accepts and processes network and non-network events to produce bill-ready events that can be processed by CBM (Customer Billing Manager-18) to generate bills and reports. ERP 16 actively collects raw events from different network elements 28 and also processes input from other external entities and subsystems of the Customer Care and Billing System, for example, the Debit Card Center. The collected events are formatted, validated, assembled and checked for duplicates. After the events are rated and summarized, they are stored as events in the database server 29. ERP 16 also generates recurring and non-recurring charges, performs taxing, and performs final pricing of events (for example, discounting) as part of the bill day process. The billable events in the database are accessible for billing and can also be retrieved by CCM (Customer Care Manager) 12 to answer customer queries. ERP 16 fully supports convergence and net taxing, provides flexible near-real time rating and pricing, allows flexible definition of tariff models and price plans, allows flexible definition of usage record formats and it provides for effective-dating of customer and reference data

The Customer Bill Manager (CBM) 18 is the billing engine and interfaces with bill generation 30. CBM 18 expects bill ready events as input. As defined in the customer database, CBM 18 determines the order (e.g., international calls after local calls, recurring charges before local call charges) and manner is which the events should be placed on the invoice (e.g., in detail, summarized). CBM 18 further supports the production of documents including bills, contracts, dunning letters, balance letters, welcome letters and tariff letters. CBM 18 is responsible for triggering the cycle, collecting data, formatting it and then providing to the appropriate media CBM 18 provides a robust and user-friendly means for creating documents. It is very rich in functionality and new documents can be quickly and easily implemented. Document verification is provided so that selected documents can be verified prior to sending the mass batch of documents. Convergence is also fully supported where one document can include cross-market services.

Order Processing (OP) 22 provides active order processing, order management and service activation across a convergent platform. OP 22 accepts requests for work as input. The work request is analyzed to determine the tasks required to complete the request, as well as all scheduling dependencies that are required. The result is a workflow, identifying the proper order in which tasks must be completed, the estimated time required to perform a task, and the type of resource(s) required for each task. OP 22 actively monitors each task, generating alarms for potential error conditions, such as tasks failing to start or finish at their scheduled time. OP 22 completely automates order scheduling and processing. This eliminates time-consuming errors due to missed steps and improper work implementations, freeing valuable resources to perform other value-added functions. If a customer purchases a product that requires activation, for example a new phone line or call waiting, CCM 12 passes this request to OP 22, which determines whether the feature can be activated automatically on the network element 28, or whether workforce intervention is needed. Assuming automatic activation is possible, the OP 22 subsystem translates the request to the low level activation request for the network element 28. Once OP 22 received the response from the network element, OP 22 informs CCM 12 of the success/failure of the service activation. If automatic activation is not possible—i.e. an order requires tasks to be done by workforce—sophisticated scheduling and optimization take place, where both the elapsed time to fulfill the order and workforce utilization are optimized, such that the schedule has the shortest possible critical path, and the workforce has minimal or no “gaps” in their schedule.

The Financial Event Engine (FEE) 20 is an event processor that accepts, applies, assesses the impact of, and follows up on customer financial transactions. FEE 20 processes debit transactions, typically charge transactions, which result from the purchase and use of products by customers. FEE 20 also processes credit transactions, including payments, adjustments, and refunds. FEE 20 is able to process many types of media, from cash and checks to money orders and electronic transfers. FEE 20 uses internal rules to determine the event's transactions type (e.g. remittance, discount, etc.), the account ID to determine the correct customer account balance, and the internal rules to determine the impact of the event on the customer's account balance. FEE 20 also updates the provider's General Ledger from the account balance. Finally, FEE 20 triggers follow up events appropriate to the accepted financial transaction such as sending invoice information to the accounting system at the end of the invoice cycle. Experience has shown that several proven conventional products exist (such as SAP and Oracle Financials) that are quite sufficient at fulfilling this function. Additionally, each client may have a preference to the financial engine used. A third party financial engine can be provided for this component

The invention is a Customer Care and Billing (CCB) solution, providing convergent and modular functionality, real-time information, drastically shortened time to market, and a flexible architecture.

The invention is a comprehensive solution to meet the functional and technical requirements facing Telecommunication Providers. This will enable a provider to implement a customer care and billing solution that has the sophistication, flexibility, robust functionality and high performance that is essential to compete successfully in a deregulated market.

The discussion of the invention divided into two sections: functional and technical.

Functional Description

The functional architecture of the invention is built on a combination components. Table 1 below provides a high level cross-reference of each component and the functional areas.

TABLE 1
Component Cross-Reference

| AMS Application Name | Functional Areas Components |
|---|---|
| Customer Care Manager | Customer Care Management |
| (CCM) | Customer Care Support |
| Order Processing (OP) | Task Management |
| | Order Processing |
| | Service Activation |
| Event Rater and Pricer (ERP) | Message Processing |
| | Event rating and pricing |
| Customer Billing Manager | Invoice Cycle Management |
| (CBM) | Document Approval Process |
| | External Interfaces |
| | Document Formatting |
| Financial Event Engine | Payment Processing |
| (FEE) | Adjustments and OCCs Management |
| | Write-offs |
| | Accounting Interfaces |
| Product and Services | Creation and Management of |
| Manager | Products and Services |
| (PSM) | Standard tariff management |
| | Management of pricing plans |

The invention considers modularity to be the segregation of business system functionality into functionally complete components that can be implemented either together as a total solution, individually to address specific needs, or in some combination. The key is to ensure that each component is an independent and self-contained unit, which by itself, completely performs some set of functions. Because each component must also enable ease of integration with legacy systems, standardized interfaces are provided for each component, where the interface includes all information that is needed by the sending and receiving system. All interfaces are built into the invention object model as separate objects.

The following scenarios depict the modular capabilities of the invention, highlighting the ease of integration with other invention components or legacy systems.

Modularity Scenario 1

Rating and Billing Engine Only

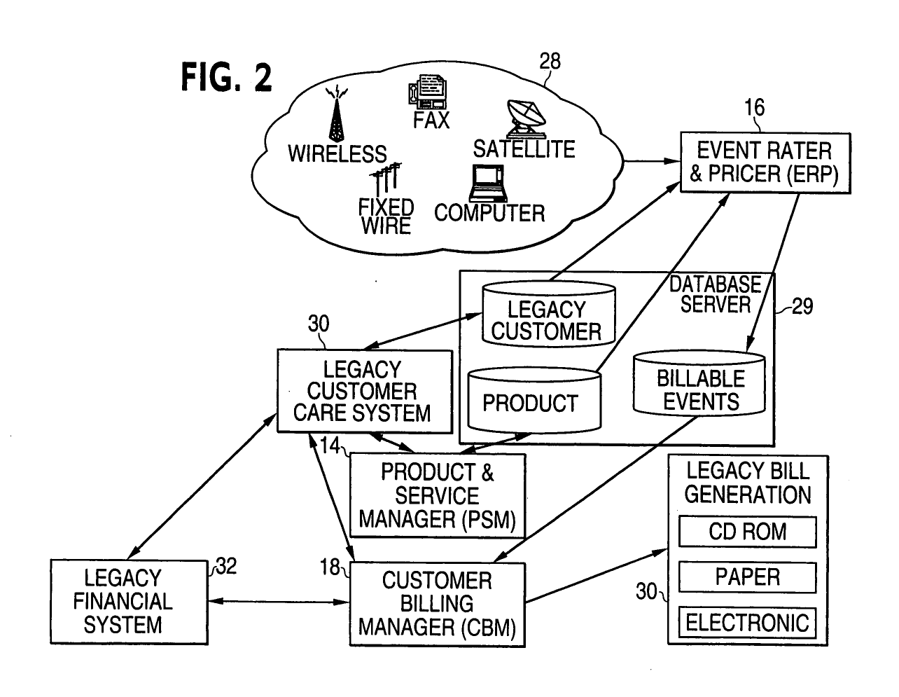

In this scenario, a potential client feels that their Operating Support Services (OSS) topology is sufficient in most areas, with the exception of rating and billing. The client requests a replacement system that will allow them to implement a robust rating engine and bill generation process, while still maintaining their existing systems for customer care, financials management, order processing, and network access. FIG. 2 illustrates the components used.

The diagram illustrates the integration of the ERP 16, CBM 18, and PSM 14 components of the invention with the clients existing/legacy components. In this integration the PSM 14 becomes the single product catalog for the customer, maintaining products and price plans in the Product Database. The legacy customer care system 30 interfaces with the Product and Service Manager via the standardized PSM interface to present product information to the end user. The ERP 16 accepts billable events, and determines rating and discounting plans based on the subscriptions in the legacy customer database. The CBM 18 creates invoices for the customer based on the billable events collects and priced by ERP 16. Additional product information is taken from the PSM 14. The CBM 18 communicates billed charges to the legacy financial engine 32 via the standardized CBM interface. The CBM 18 communicates invoice formats to the bill production devices via standardized CBM interfaces.

Modularity Scenario 2

Rating Engine Only

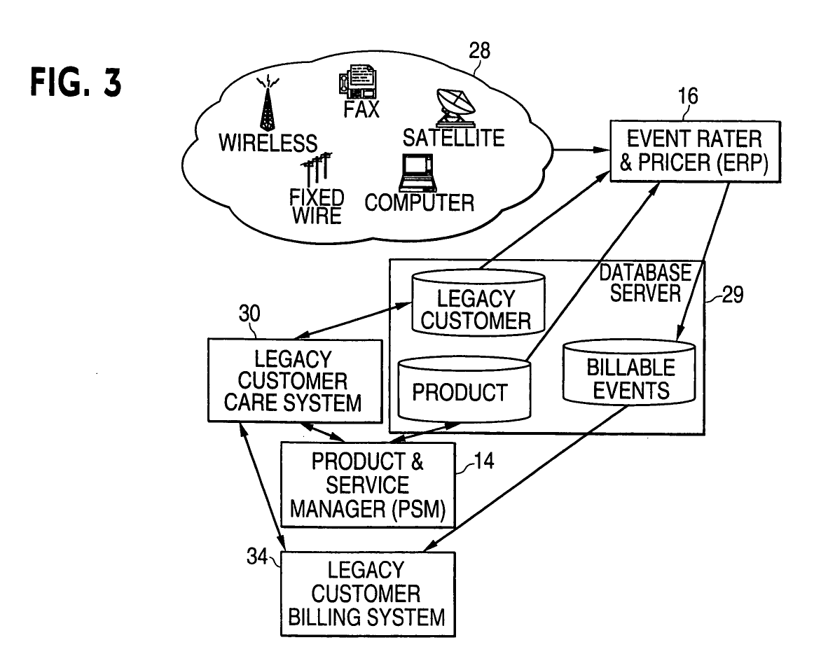

In this scenario, a potential client feels that their OSS topology is sufficient in most areas, with the exception of rating. This situation occurs frequently with the rise of convergent price plans. The client requests a replacement system that will allow them to implement a robust rating engine, while still maintaining their existing systems for customer care, billing, financials management, order processing, and network access. FIG. 3 illustrates the components used.

FIG. 3 illustrates the integration of the ERP 16 and PSM 14 components of the invention with the client's legacy components. The PSM 14 becomes the single product catalog for the customer, maintaining products and price plans in the Product Database of the server. The legacy Customer Care system 30 interfaces with the Product and Service Manager 14 via the standardized PSM interface to present product information to the end user. The ERP 16 accepts billable events, and determines rating and discounting plans based on the subscriptions in the legacy Customer database. At bill time, the ERP 16 sends billable events to the legacy Bill Generation process via the standardized ERP interface. The legacy Billing Generation process receives additional product information from the PSM 14. The legacy Billing Generation process communicates billed charges to the legacy Financial Engine via legacy interfaces.

Modularity Scenario 3

Customer Care Only

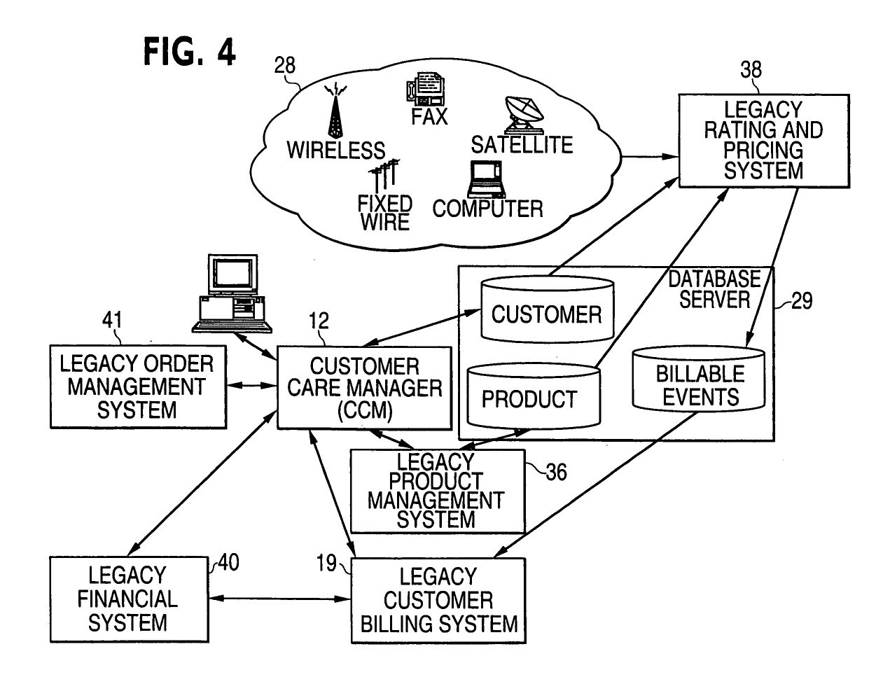

In this scenario, a potential client feels that their OSS topology is sufficient in most areas, with the exception of Customer Care. This situation will become more prevalent with the rise of customer self-care—the ability for customers to access and maintain their own information via the Internet. The client requests a replacement system that will allow them to implement a robust customer care process, while still maintaining their existing systems for rating, billing, financials management, order processing, and network access. FIG. 4 illustrates the components used.

FIG. 4 illustrates the integration of the CCM 12 component of the invention with the client's legacy components. CCM 12 becomes the single customer care facility for all or a specific sub-set of customers. The CCM 12 interfaces with the legacy Product Management system 36 via the standardized CCM 12 interface to present product information to the end user. Order management is performed by the legacy order management system 41, which communicates with CCM 12 via standardized interfaces. The CCM 12 communicates customer subscription information to the legacy Rating system 38 via standardized CCM 12 interface. The CCM 12 accepts balance updates from the legacy Financial system 40 via standardized CCM interfaces.

Modularity Scenario 4

Billing and Order Management Only

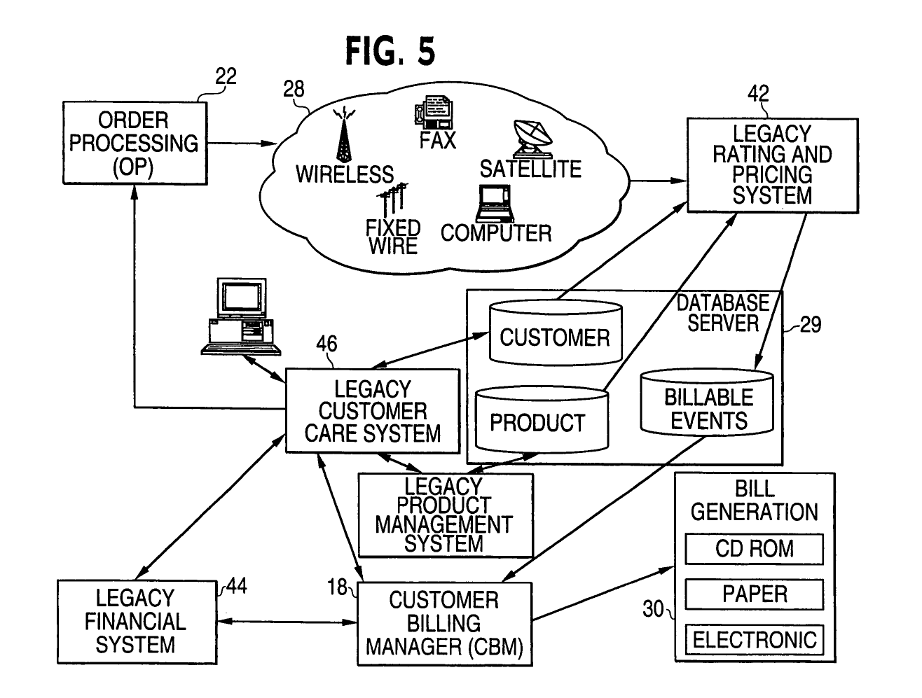

In this scenario, a potential client feels that their OSS topology is sufficient in most areas, with the exception of Billing and Order Management. This situation is uncommon, but presented to highlight the modularity of disparate invention components. The client requests a replacement system that will allow them to implement a robust billing and order management processes, while still maintaining their existing systems for customer care, rating, financials management, order processing, and network access. FIG. 5 illustrates the components of the invention used.

The diagram illustrates the integration of the ERP 16 and OP 22 components of the invention with the client's legacy components The two integrated invention components 18 and 22 are not directly integrated with each other. However, due to standardized interfaces, both components continue to function as expected. The CBM 18 becomes the billing engine for all or a specific sub-set of customers or products. The CBM 18 accepts billable events from the legacy Rating engine 42 via the standardized CCM interface to produce invoices. The CBM 18 communicates billed charges to the legacy Financial Engine 44 via the standardized CBM interface. The CBM 18 communicates invoice formats to the bill production devices via standardized CBM interfaces. Order management is performed by OP 22, which communicates with the legacy Customer Care system 46 via standardized interfaces. The OP 22 communicates network requests to the network elements 28 via the service activation software interface.

The present invention also provides convergence of the services provided providing a single customer view to CSRs such that all of the services can be brought together into a single pricing plan.

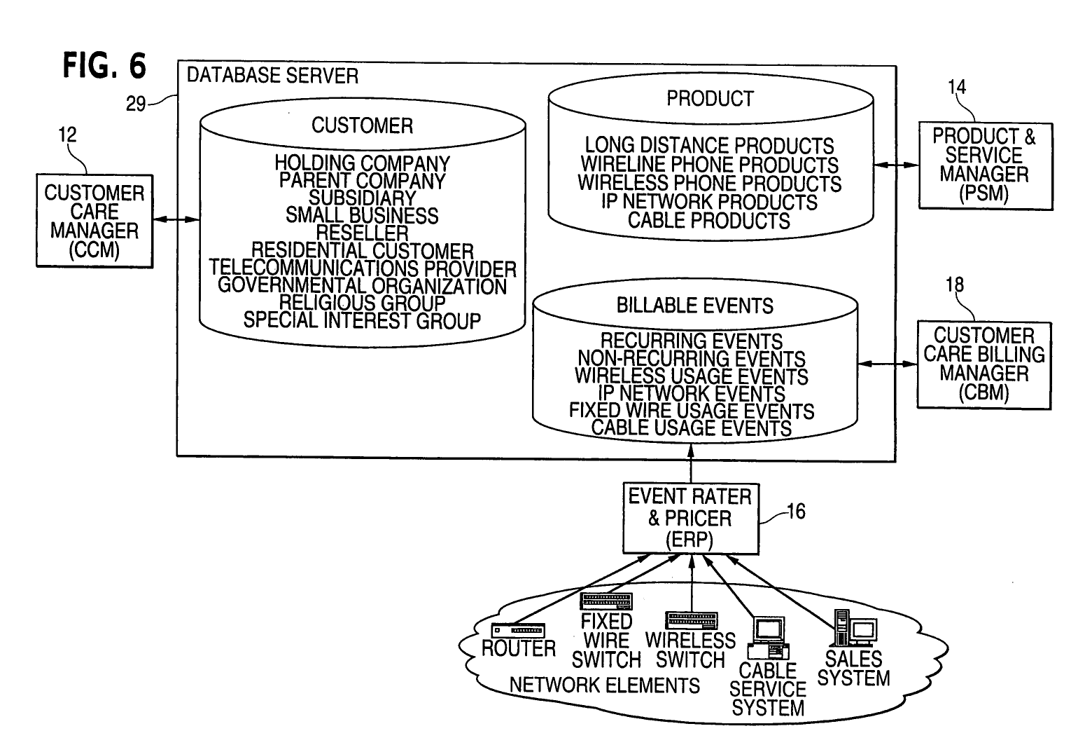

Convergence in the simplest form is the merging of the wireline and wireless worlds. This is the definition many companies use. In complex form, convergence implies the simplification of all telecommunications services to their root—electronic transmissions. A voice wireline telephone call looks identical to a wireless data transmission, which looks identical to both a request to load a new Web page or a request for a pay-per-view movie on cable TV. They are all simply electronic transmissions. The invention provides the complex form of convergence as depicted in FIG. 6. The invention is not simply designed to concurrently process wireline and wireless transactions. The invention processes any type of transaction related to telecommunications, and addresses full convergence, where a single customer can subscribe to wireline, wireless, Internet, entertainment, and cable service. The transactions for each of these different types of service are processed in a similar manner, enabling a single view for this customer, cross product discounting across all services, and the generation of a single invoice for all of these services.

Additionally, the present invention's definition of convergence enables a client to bring together all charges for a customer, regardless of whether the charge is recurring, non-recurring, or usage. For example, a customer can receive a single invoice for local recurring charges, Internet access recurring charges, pager usage, the initial sale of the pager, as well as the credit received from an airline frequent flyer program.

The key to the invention's convergence is not only that it supports all known types of telecommunications, but in its inherent design which was constructed to easily adopt to new types of telecommunications as well. Typical object models depict the business objects and relationships that support the company; the invention object model reflects abstracted concepts which are focused towards processing, rather than their real-world business counter parts. The business concepts are fully supported by the invention objects, but they are supported by the information contained in the objects rather than the objects themselves.

Convergence is evident in every component of the invention, with the existence of a single processing thread evident in each. The following scenarios illustrate the invention's support of convergence in four areas: product, customer, price plan, and billing. For each scenario, the following information is provided:

Convergence Description—not simply a definition of convergence, but the meaning of convergence in the context of the scenario

Object Model—a complete object model for the subject area is presented; the central object(s) supporting convergence is discussed

Processing—the effects on processing are noted; convergence is driven by the definition of the objects; since processing is driven by the objects, processing convergence follows the object convergence.

Convergence Scenario 1

Product Convergence

Product convergence is the fundamental point from which convergence in a billing system grows. The invention views products irrespective of their transmission method or protocol. For example, long distance service is simply long distance service. Whether the long distance call is carried over a wireline phone, a wireless phone, or even an IP network is irrelevant from the standpoint of product definition.

Object Model

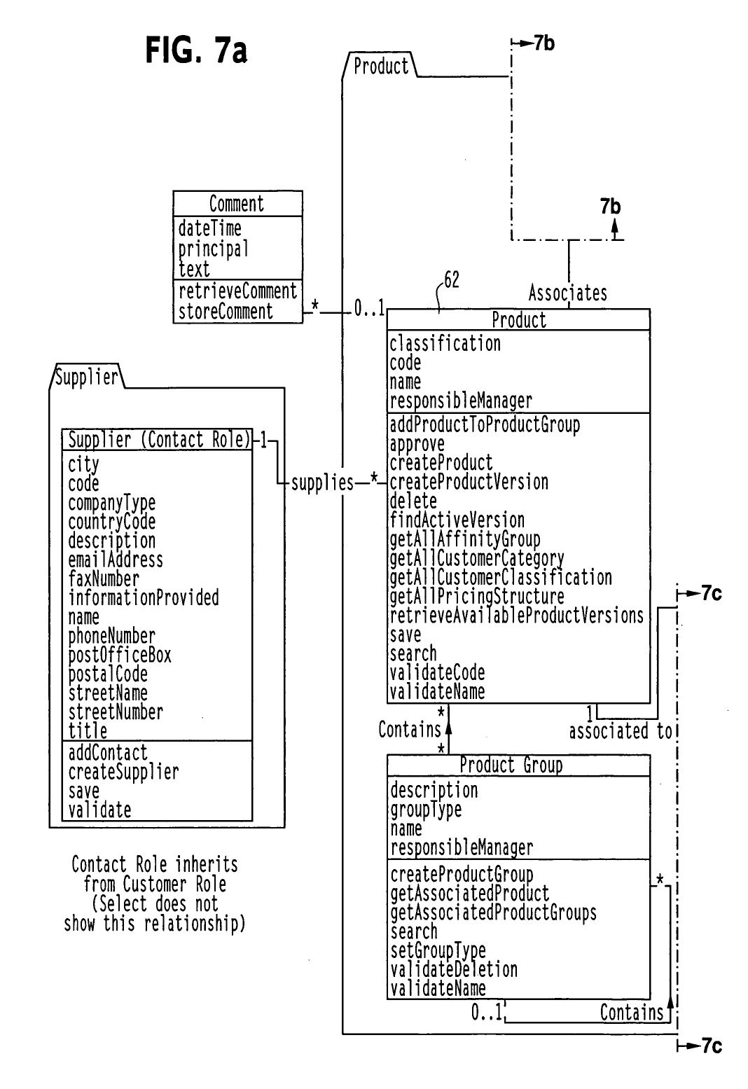

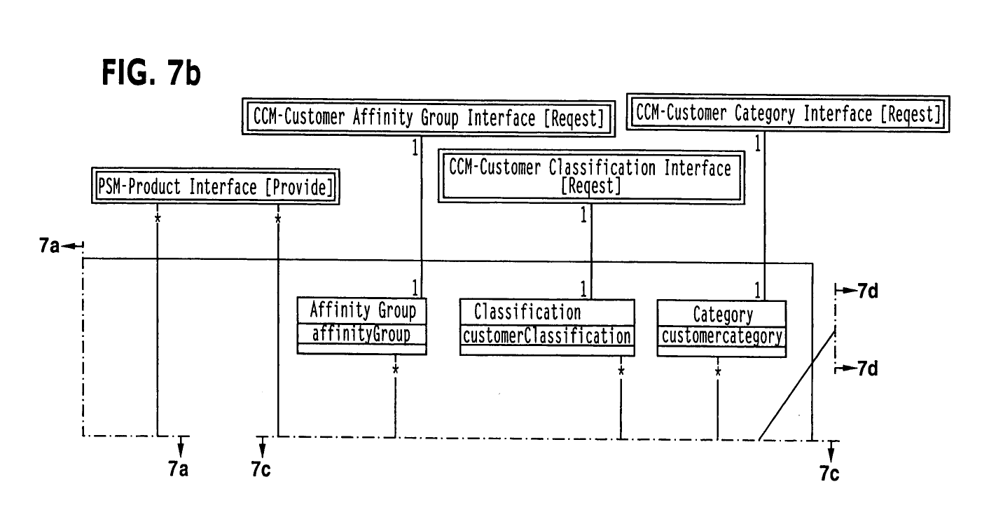

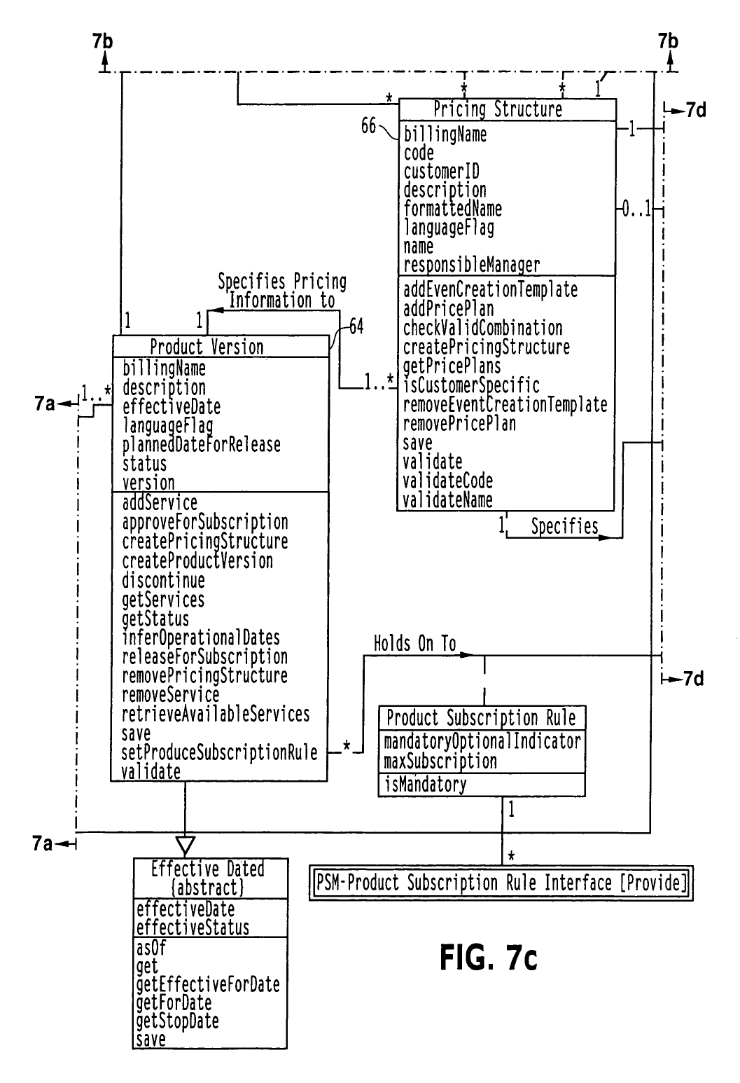

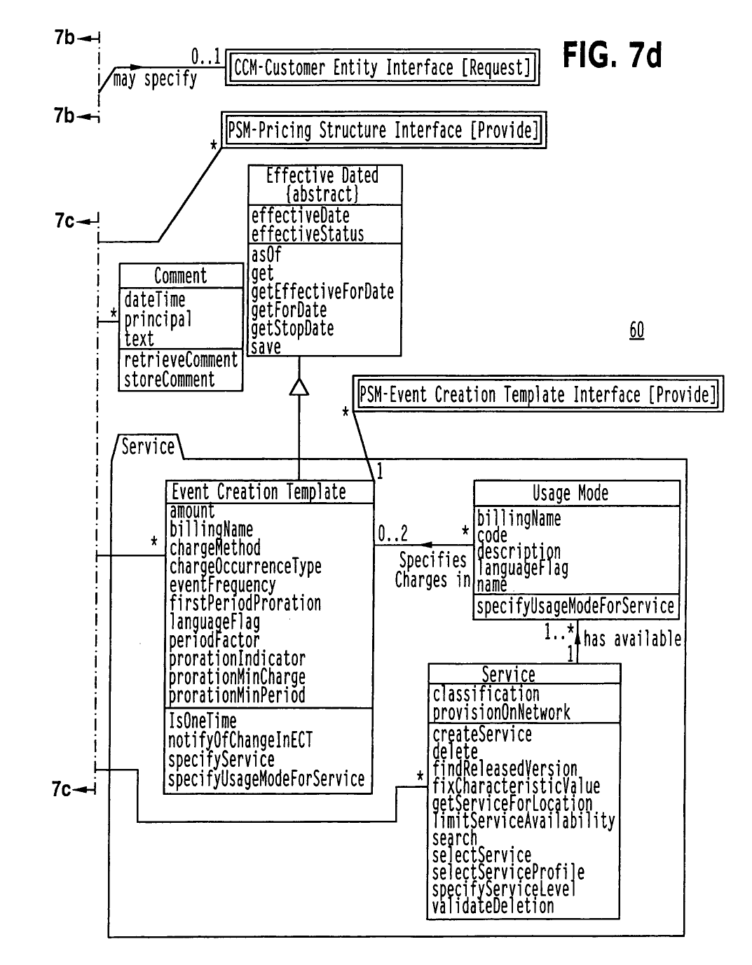

At the heart of the object model 60, as depicted in FIG. 7, is a single object called Product 62. This object is used to define all products a telecommunications provider offers, regardless of transmission method or protocol. Because of this, the object model does not represent the specific products offered. The Product object, in associated with the other objects, is an abstracted view of all objects. In the case outlined in the previous paragraph for long distance service, long distance is represented once as a product, and then grouped into different product groups (i.e., wireline, wireless, IP). Again, the object model does not represent the products offered, but provides a convergent method in which to represent all products in a common manner.

The Product Version object 64 represents the history or the product. For example, a product name may change over time, but the inherent product remains the same. The Product Version enables a provider to track changes for a product, without having to create new products.

The remaining question is: “How are rates varied?” The Pricing Structure object 66 maintains the rating information for each product, and is related to a specific product version. Each Product Version can have multiple Pricing Structures, so that different prices can be established based on service type (e.g., wireline vs. wireless), customer type (e.g., business vs. residential), or customer specific (e.g., ACME Corporation has a unique set of rates that they have negotiated).

Processing

Product processing is simplified due to the simplified object model. Product maintenance involves defining new products and modifying existing products (including product retirement). Because all products are represented in a similar manner, only one processing stream exists. The differentiator between whether a product is wireline or cable is simply a table entry, and hence, no product specific processing is required.

GUI

Similar to processing, because of the simplicity of the object model, all products are displayed to the user in a similar fashion. They may appear differently on the GUI, simply to differentiate to the user different groupings of products. For example, wireless products may have a different graphic beside them to denote a wireless product. All products can be displayed together on a single GUI to enforce the concept of convergence to the user. Additionally, the user can select a number of sorting schemes to provide a different view of products. For example, if a residential customer is requesting wireless service only, a Customer Service Representative can request to view only wireless products available to residential customers living in a specific region.

Convergence Scenario 2

Customer Convergence

The invention Customer object model takes a unique approach to understanding and defining customers. In a convergent world, operators or service providers want the full picture of their client. The residential customer named John Smith may be the same person as the John Smith who owns a small business. A provider can use this knowledge to target special products to this type of customer.

Object Model

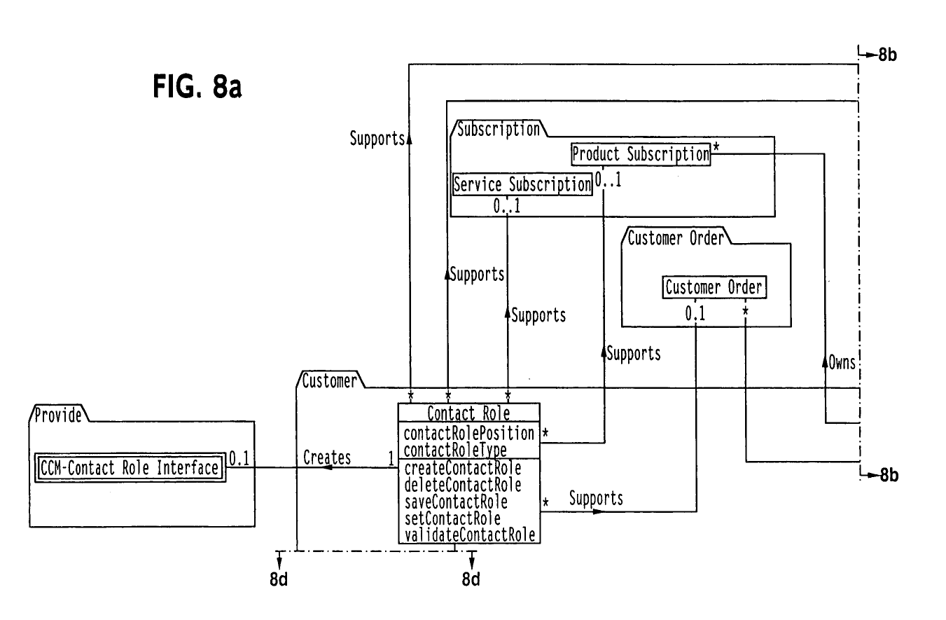

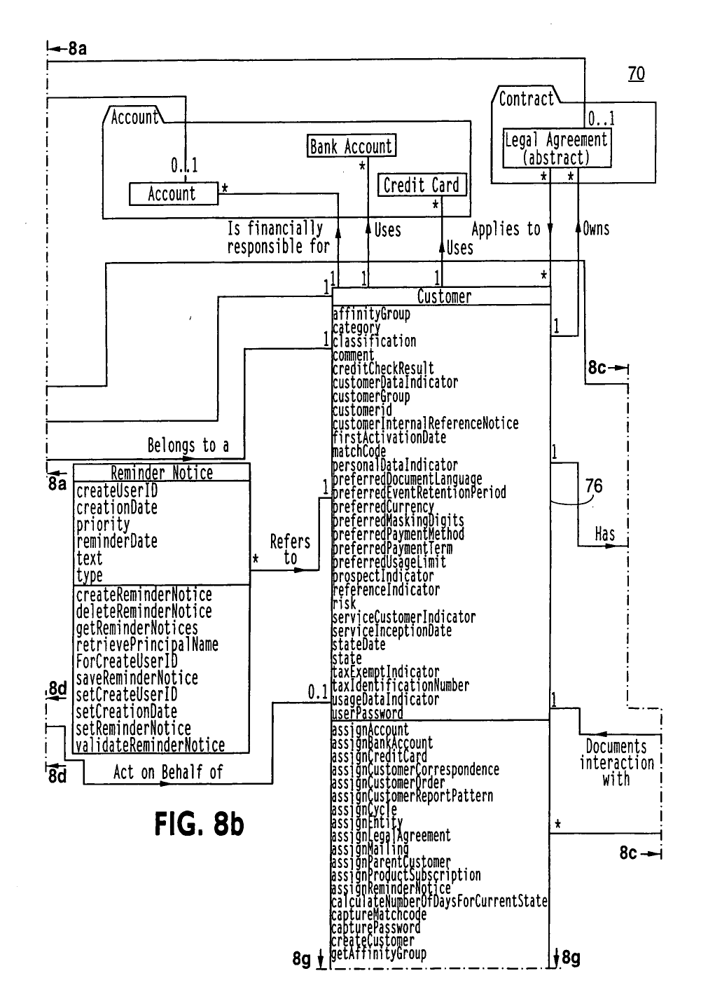

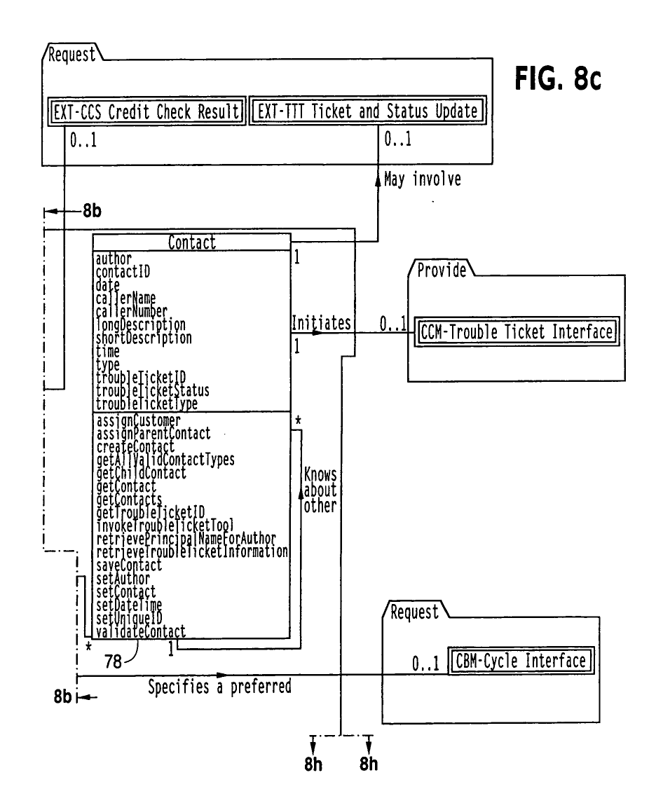

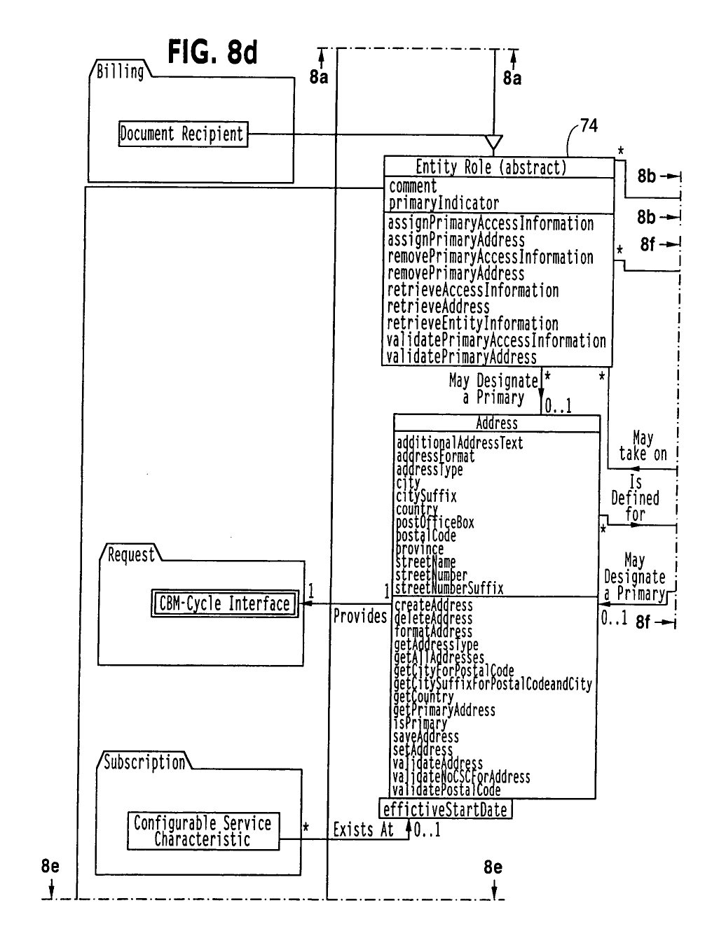

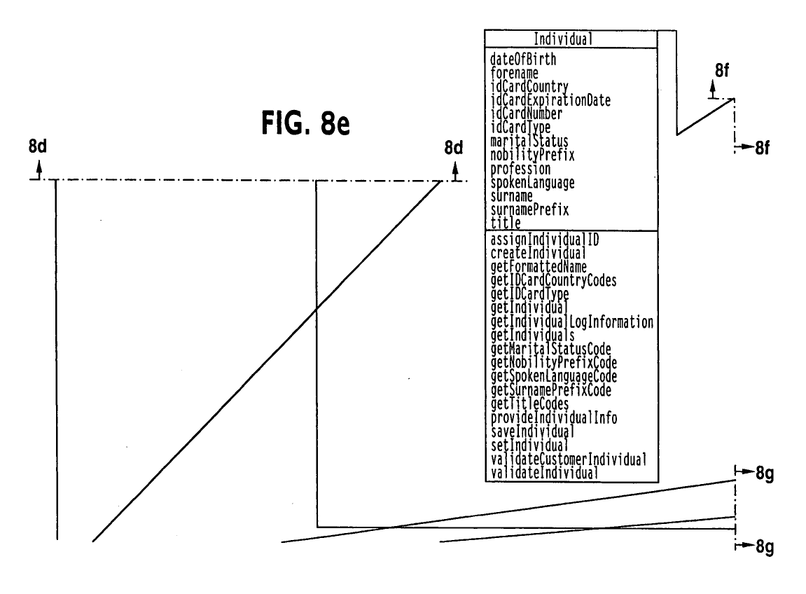

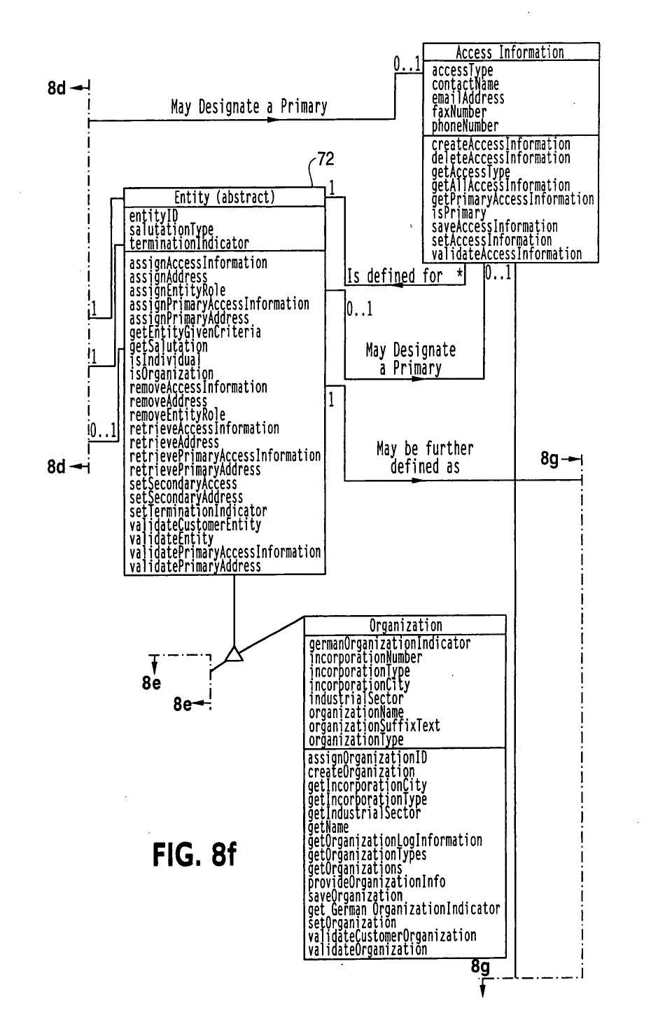

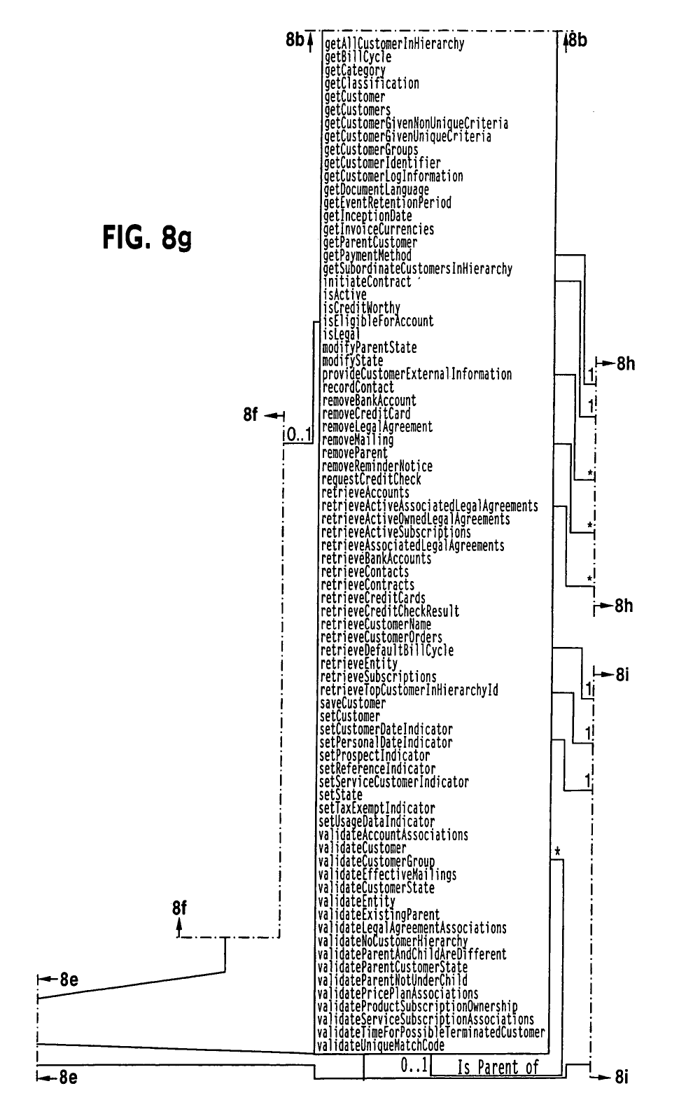

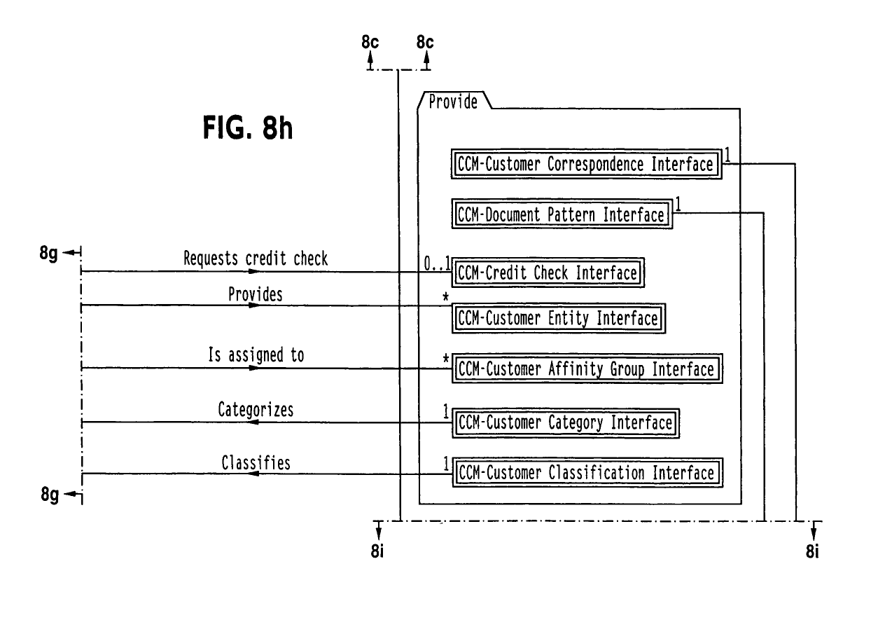

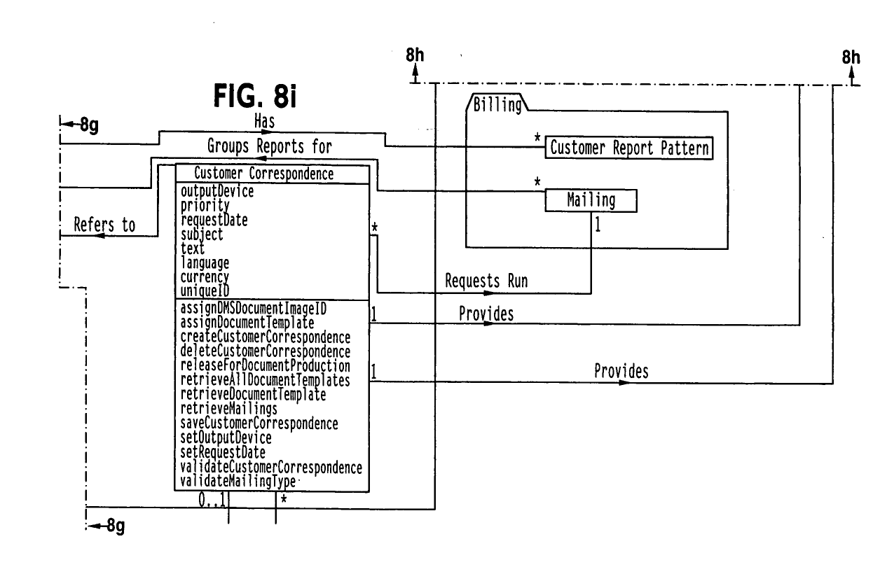

Listed below is the definition of the important objects in the customer object model 70 depicted in FIG. 8.

Entity—This object 72 represents an individual or organization in which the Telecommunications Provider is interested and has dealings. To provide a mechanism to locate all occurrences of an individual or organization in the invention. This object links all occurrences of a specific person or group. This enables a provider to recognize “Terry Harper” the residential wireless customer as the same “Terry Harper” that is the Internet service contact for a major corporation.

Entity Role—This object 74 represents the various positions in which a customer can interact with the Telecommunications Provider. Multiple roles per customer are permitted. For example, a customer may have multiple contacts. Customer—The overall entity with which the Telecommunications Provider. Customer Contact—An individual within the customer's organization which is used in dealings relating to a specific area, such as contracts or purchasing. This object provides a mechanism to define and differentiate the customer from the contacts within the customer's organization.

Customer—This object 76 represents the individual or organization which is the overseer. This could be a holding company, parent company, subsidiary, small business, reseller, residential customer, the Telecommunications Provider (for internal billing purposes), governmental organization, religious group, or special interest group (e.g., AARP, AAA). The attributes associated with Customer object include name, address, customer ID, demographic information, marketing information, and preferences (e.g., language). This object was constructed due to the complex nature of business or organization customers. These types of customers are generally large with multiple invoices, accounts, and locations. The Customer object serves as the “umbrella” under which all information for this entity exists.

Contact Role—This object 78 represents the individual or organization within the customer's organization which is used in dealings relating to a specific area, such as contracts or purchasing. The invention supports contact as a generic contact, or as one of the following specific contacts:

Invoice Recipient—An individual or group within the customer's organization to whom the Telecommunications Provider sends an invoice.

Invoice Payer—An individual or group within the customer's organization responsible for payment of services received.

Statement Recipient—An individual or group within the customer's organization to whom the Telecommunications Provider sends a statement (i.e., report).

Shipment Recipient—An individual or group within the customer's organization to whom shipments of products are sent.

Product User—An individual or group within the customer's organization to whom a product is assigned for use.

Guarantor—An individual or group outside of the customer's organization who is assuming partial or full financial responsibility for the customer, in the event the customer fails to make payment.

Legal Entity—An individual or group within the customer's organization who is permitted to make legal decisions for the customer.

In dealings with the customer, it is important to know the how the individual fits into the customer's organization. Contacts allow the Telecommunications Provider to understand the inter-workings of their customers. Information can be tracked specific to each of the contacts to help the Telecommunications Provider better deal with the customer. For example, if payment is not received, the individual responsible for the payment can be contacted directly by finding the Invoice Payer for the services. If the Telecommunications Provider desires to market new services to the customer, they can contact the marketing contact for the customer.

Processing

Product processing is simplified due to the simplified customer object model. Customer maintenance includes defining new customers and modifying existing customers (including customer de-activation). Because all customers are represented in a similar manner, only one processing stream exists. The differentiator between whether a customer subscribes to wireline or cable products is maintained at the subscription level, and hence, only minor customer type specific processing is required.

At the subscription level, processing also follows a common stream, to support the concept of convergence. Product subscriptions may vary depending on the type of service. Because of this, additional product specific logic is added where needed, in addition to the common stream. For example, a provider supporting wireless services may also support immediate over-the-air activations. To support this, the subscription process performs extra functions for wireless service, that are not performed for any other service.

GUI

Similar to processing, because of the simplicity of the object model, all customers are displayed to the user in a similar fashion. The concept of differentiating customers by line of business does not exist in the invention. A customer is simply a customer.

Convergence Scenario 3

Pricing and Billing Convergence

Billing convergence can only take place if convergence is accounted for as soon as the billable event is received, with all billable events being processed in a similar manner and follow a similar structure. While each billable may have specific nuances and may appear different upon entry, the key is to determine the fundamental structures that every billable event has in common, and create a single billable event, around which all processing is developed.

Object Model

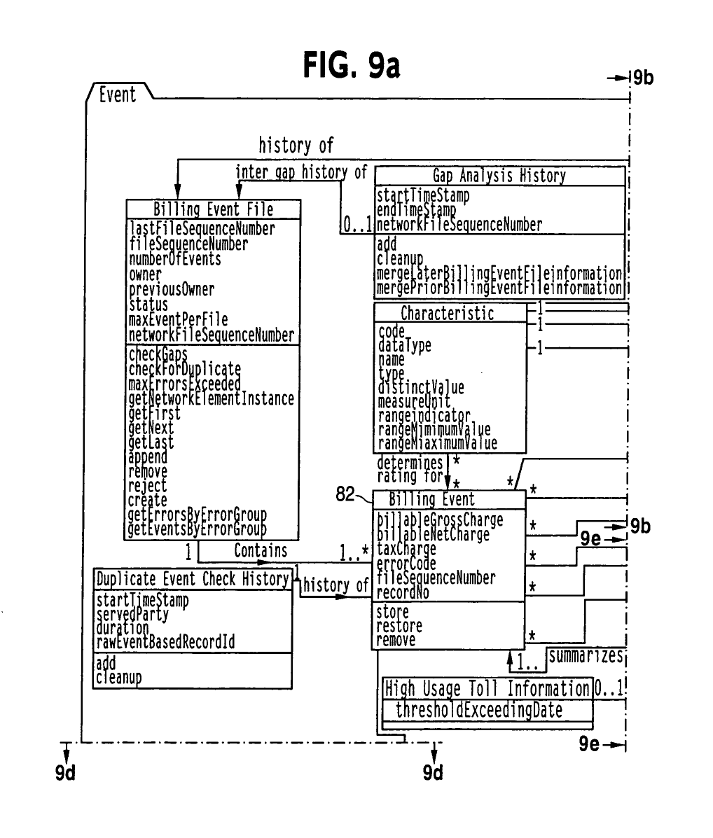

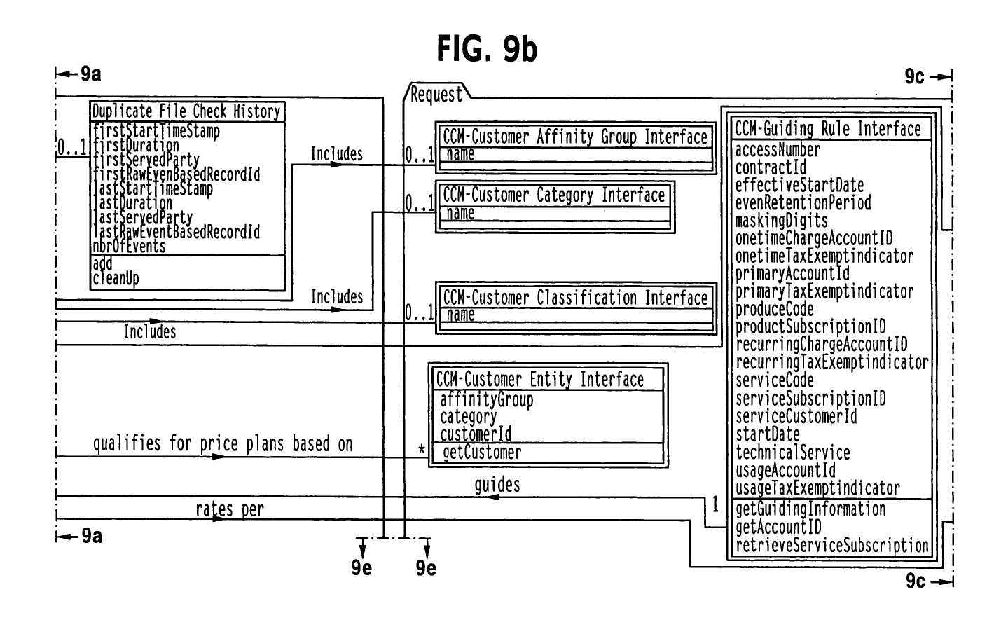

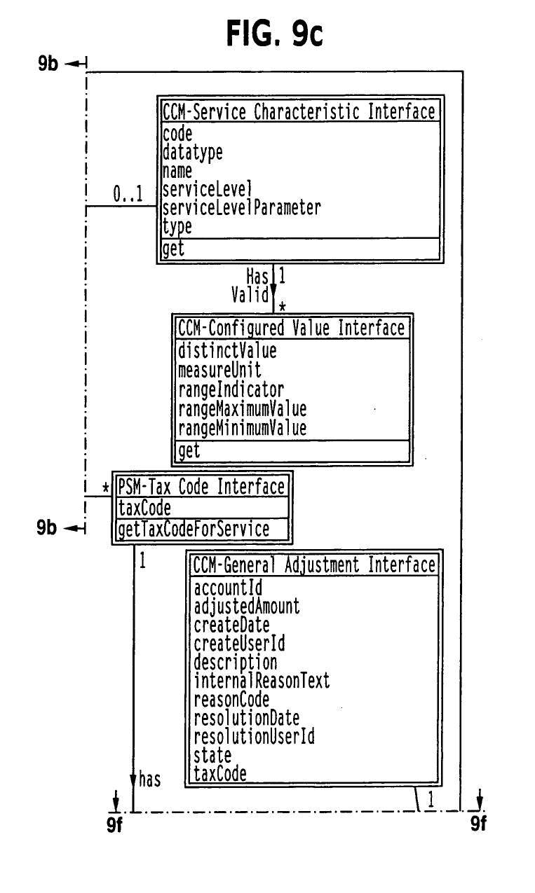

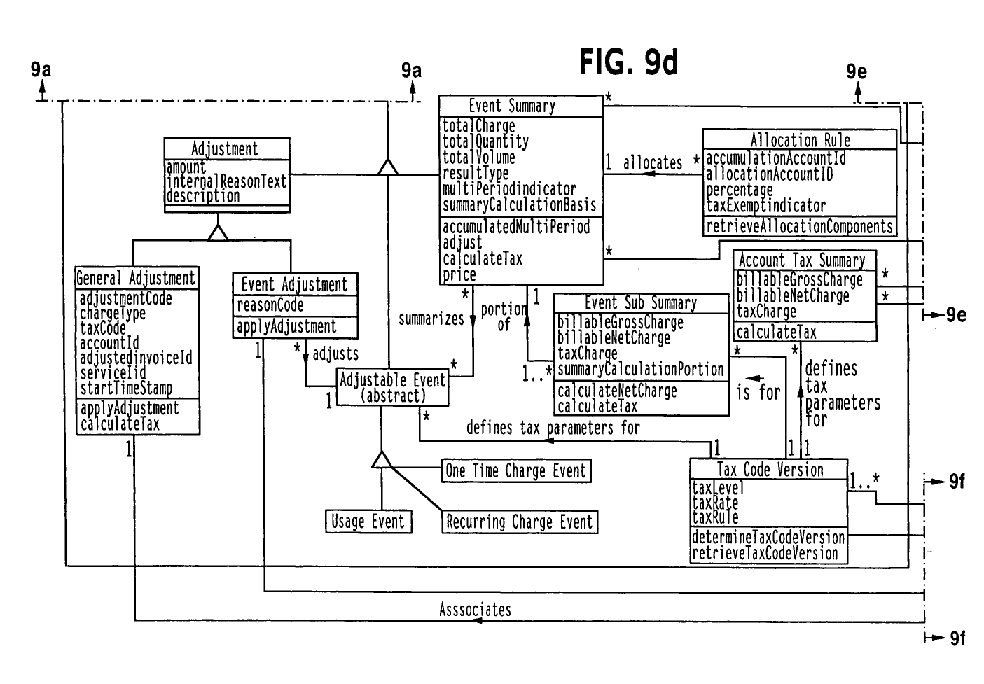

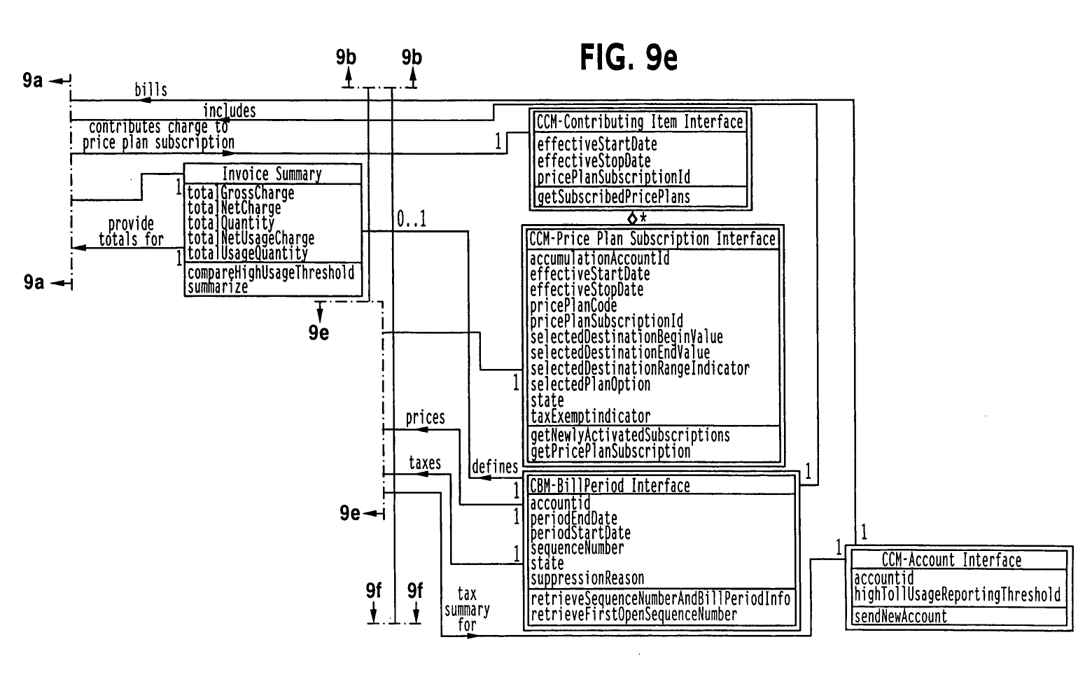

To enable convergence, the invention has defined a single object 82 (see FIG. 9) to be a billable event. This object contains the following attributes to date:

billableGrossCharge—The billable charge of the BILLING EVENT including tax.

billableNetCharge—The billable charge of the BILLING EVENT excluding tax.

taxCharge—The amount of tax calculated for the BILLING EVENT.

errorCode—The errorCode can contain one ore more ERROR CODES that get assigned to the BILLING EVENT during processing in the case an error is detected.

fileSequenceNumber—ERP internal unique sequence number of the BILLING EVENT FILE which contained the BILLING EVENT after formatting.

recordNo—The record number of a particular BILLING EVENT from a BILLING EVENT FILE.

Each attribute is required for all billable events, regardless of whether the event is for wireline, wireless, Internet, or cable service. For the invention, the billable event has been abstracted to a single base object, with additional associated objects for additional information that is specific to a particular type of usage. The end result is a fairly complex object model 80, that does not precisely depict the business. A business analyst cannot look at the object model to determine the exact services that a provider is offering. This information is inherently stored in the information that is maintained in the objects, rather than denoted by the objects.

The invention billable event object model is presented in FIG. 9. Note that the objects conform to processing boundaries rather than service boundaries. The Billing Event object sub-classes into three other objects: adjustment, adjustable event, and event summary. The design of the model is directed by processing. Adjustments can be either general or event-specific, and require different processing than an event that is simply billed. Because the processing is different, the object model reflects this. Processing for wireline and wireless adjustments is identical; hence, no differentiation is needed.

Processing

Processing in an object-oriented system is driven by the design of the object model. Because the invention is designed as a convergent solution, the objects have been abstracted Because the objects have been abstracted to reflect processing commonalities, processing is much simpler. A single set of common processing is being created for all billable events. The application of flat rate to a billable event is identical, regardless of service type. The rates may be different, but the application of the rates is identical.

In many cases, service specific logic is required. The invention addresses this in one of two ways. If the processing is identical, but the values are different (e.g., rates for wireless service will vary from wireline), the rates are stored in user maintained tables. This preserves the common stream processing. If the processing is specific to a service type, (e.g., one type of service uses total off-hook time for duration, while another uses connect time), a common processing stream is created with alternative processing for specific event types. Even when alternative processing is used, the event continues along the common path once the exception logic is completed. The key difference is that all usage follows a single path. There will be instances where a particular type of usage requires unique processing, but this processing is built into the common processing path.

Traditionally, different products have been billed by different systems. For example, if a customer walks into a phone store and purchases a phone, they must pay for the phone before they leave. This occurs because the phone store billing system is separate from the monthly billing system. The invention eliminates this difference. In the invention, the charge for a phone is simply a non-recurring charge, which enables a customer to walk into a phone store, pick out a phone, and have the charge billed on their monthly bill. The need for a separate billing system is eliminated.

GUI.

Similar to processing, because of the abstraction of the object model, all price plans are displayed to the user in a similar fashion. The true power of convergence is witnessed through these GUIs. Traditional systems enable the provider to define price plans, but prohibit them from crossing lines of business. Because of the convergent nature, the invention views all products and services alike. Likewise, different types of charges (i.e., recurring, non-recurring, and usage) can be combined in a single plan. Defining a new price plan is a matter of selecting the services which should be included and defining the prices which should be charged. Since all products look alike, the invention enables a provider to define cross-product price plans, enabling convergent pricing.

Detailed Description of Each Component

The following sections each give a detailed description of the components in the proposed Customer Care and Billing solution.

Customer Care Manager (CCM)

The Customer Care Manager (CCM 12) provides proactive customer support. Its enhanced functionality provides both standard and advanced customer care functions. CCM 12 provides a complete view of a customer's products and discount plans across markets. CCM 12 interacts with external organizations (for instance, credit checking), providing advanced features to additionally support scripting and validations. With CCM's sophisticated user interface, customer service representatives can spend more time focusing on the customer and less time on manual and redundant tasks. New products, new customer types, and new customer care management strategies can be quickly implemented, thereby reducing the time to market for such changes.

CCM Functionality

The Customer Care Manager (CCM) 12 focuses on the customer, including every aspect related to the customer such as demographic information, geographic information, marketing information, customer hierarchies, account structure, invoices, statements, contracts, and subscriptions. CCM 12 is the single source for all customer information, regardless of whether it is a business customer, residential customer, or both. CCM 12 allows A client to tailor customer care functions to each customer for example, hierarchies, invoices, statements, price plans, product definitions, customer structures, contracts, and groups.

Overview

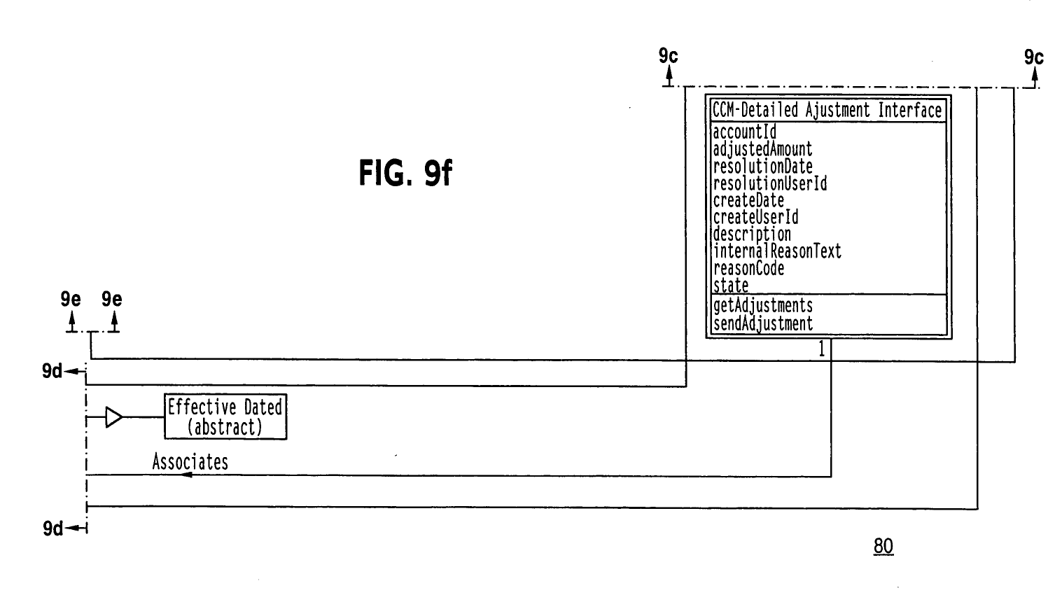

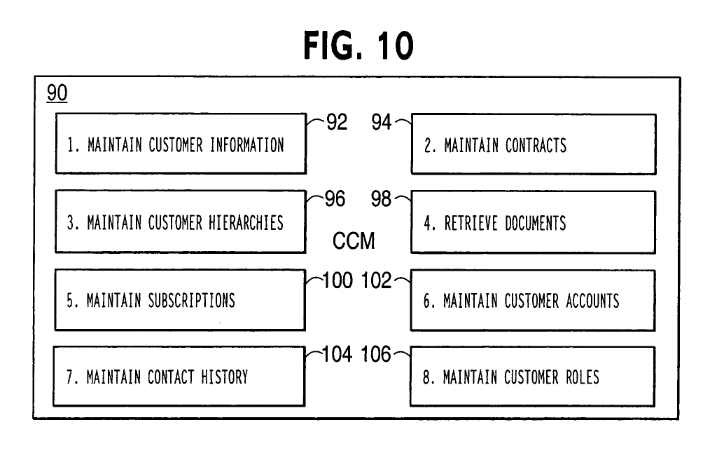

FIG. 10 provides a description of the major functional areas in CCM 12. The following describes each of the eight areas for CCM 12 as depicted in FIG. 10.

Maintain Customer Information 92 provides maintenance of all basic information related to the customer. Customer information includes name, address, demographics, preferences (such as language), geographic, and marketing information.

Maintain Contracts 94 provides maintenance of all legal conditions relating to contracts. This includes the effective date of the contract, the account to which the contract is associated, and the invoice on which the charges should appear.

Maintain Customer Hierarchies 96 provides hierarchy maintenance. Examples of hierarchies include customer (for example, parent company/subsidiary, holding company relationships), account (to reflect the customers financial tracking and reporting structure), and invoice payer (to reflect financial roll-up responsibilities).

Retrieve Documents 98 provides the ability to retrieve documents such as incoming documents scanned and stored, or outgoing documents such as bills and dunning letters. These documents can be retrieved to support customer inquiries.

Maintain Subscriptions 100 involves creation and maintenance of customer requests for service. Includes product recommendations.

Maintain Customer Accounts 102 provides maintenance of account information, such as credit scores, credit class, credit limit, and payment method.

Maintain Contact History 104 supports history of all contacts with the customer, including product inquiries, billing inquiries, price quotes, and complaints. Future customer contacts can be scheduled.

Maintain Customer Roles 106 provides maintenance of customer designated roles, which could be customer, invoice payer, invoice recipient, statement recipient, legal entity, guarantor, shipment recipient, and product user.

Components

CCM 12 has three main components: Customer, Account, and Contract.

The customer is the individual or organization, which is the overseer for all dealings with a provider. In other words, the customer is the “umbrella” under which all information for this entity exists. The customer could be a holding company, parent company, subsidiary, small business, reseller, residential customer or governmental organization. The attributes associated with the customer include name, address, customer identifier, demographic information, marketing information, and preferences (e.g., language). This information is global to the entire customer. Some ways that CCM 12 supports the customer include:

Finding the customer—CCM 12 is designed with customer access in mind. Multiple paths into the customer are included, such as customer identifier, customer name, account identifier, MSISDN, invoice number, or some combination of these. In addition, CCM 12 supports Soundex Style and wildcards. Soundex Style performs a matching on similar sounding words. For instance, a request for the name Martin, spelled Martin, would return matches of M-A-R-T-I-N and M-A-R-T-E-N. Wildcards involve entering only a portion of the customer's name, with the invention returning all matching names.

Maintaining customer information—Once the customer is found, the maintenance process can begin. CCM 12 has access to a significant amount of information related to the customer. In CCM 12, different addresses are available for different types of correspondences (e.g., invoices, statements, marketing literature, and shipments). CCM 12 maintains one set of addresses for a customer which can be reused for different purposes. CCM 12 also maintains information such as demographics (for example, age), geographic information (for example, geographic classifications), preferences (for example, language), and marketing information (for example, affiliations to groups). This information can be used to stratify different groups of customers for various reasons such as discounts and marketing efforts.

Maintaining groups and hierarchies—Groups can be maintained for various reasons, either internal or external to a provider. Internal reasons include administrative changes (for example, identifying customers affected by a change) and location groupings (for example, identifying a group of individuals that live at a single address). External reasons include: marketing (for example, identifying individuals of a certain age group to target them for specialized promotions) and discounts (for example, identifying members of a particular organization). Hierarchies are structured collections of customers which have definite parent/child relationships. Hierarchies are used to reflect parent/subsidiary relationships and relationships to holding companies.

Maintaining roles—Customer roles are types of contacts and are a mechanism to identify key contacts and to better understand the customer's organization. In one case, a customer may be a residential customer. In another case, he could be the invoice payer for a large corporation. By identifying roles, it provides a mechanism to link all occurrences of a person or group. The person or group is no longer a set of disjointed entities.

Maintaining customer invoice/statement preferences—Customers sometimes request many things such as price plans, rates, contract conditions, and invoice formats. Due to the financial and cost tracking reasons, customers may prefer that specific types of charges be billed to specific groups. For example, calls from a certain set of phones are strictly research and development oriented, so these calls are billed separately, as they have different taxing requirements than calls which profit the company. Marketing messages are placed on invoices and can also be personalized for a customer. For example, a service representative may realize that a customer is reaching his/her 25th wedding anniversary.

A marketing message can be placed on the customer's invoice recognizing this occasion.

Account—Customers typically divide themselves into manageable sub-groupings such as districts, accounts, market areas, or areas of responsibility. Support for this sub-grouping helps the customer with its internal financial and cost tracking (such as internal billing, invoicing, reporting). CCM 12 provides the ultimate flexibility for a provider to support the customer's organizational structure and to provide services (for example, invoicing, reporting) at the organizational level required by the customer. Some ways that CCM 12 supports the customer include:

Maintaining accounts—The maintenance of a customer's account(s) involves the definition of new accounts, the modification or deactivation of existing accounts, and the modification of the account hierarchy. Account maintenance also provides the ability to view account history.

Maintaining credit information—Information relating to the customer's credit worthiness is maintained based on the customer's actions. For example, late payments may lower a customer's credit worthiness and may trigger a recalculation of the customer's credit score and credit class. CCM 12 provides the ability to capture an internal credit score, to alleviate the cost of external credit information. In addition to credit scores, CCM 12 also maintains a credit limit.

Contract—The contract stipulates terms, effective dates, guiding rules (which indicate who should pay for each of the individual saleable items in the contract), and invoicing rules (which indicate the invoice on which the saleable item should appear). Because of the guiding rules, some components of the saleable item can be billed to one account while other components can be billed to another account. Some ways that CCM 12 supports the contract include:

Guide Rules—Guiding rules provide the flexibility for a customer to allocate its charges to multiple accounts. For example, if a convergent package was offered, by stipulating the conditions of the purchase as part of the contract, the wireless usage charges could be billed to one account, the wireline usage charges to a second account, and the recurring charges for both wireless and wireline could be billed to a third account.

Price Quotes—Customers may call for a price quote. CCM 12 maintains a history of price quotes to support ensuring that the quote is implemented and used.

Product Recommendations—CCM 12 uses scripts to perform product recommendations. A script is defined in the manner of a decision tree. By following this script, product recommendations can be provided to the customer.

CCM Task Examples

This section provides examples of tasks that can be supported in CCM 12. Examples for typical customer-related activities are: Update an address, Change bank account information, Search for a customer based on search criteria, Inform the customer about changes to his/her service, Display customer data, Maintain customer hierarchies, Schedule future-dated customer related activities such as reminder to contact the customer, Perform-risk check, Verify insurance policy, Support customer complaints, and Proactively identify and manage potential customer turnover. Examples for typical account-related activities are: Change payment methods, Assign products/services to an account, Display the history of an account, Modify the account structure, View changes for current period, and View document images, Perform credit check. Examples for typical contract related activities are: Choose a contract, Cancel a contract, and Replace a contract with another one. Examples for typical subscription-related activities are: Activate a service, Change MSISDNs or tariff types, Add a service (like fax or mailbox) to a product, Deactivate a service, Transfer a service, Display the history of a service, Modify the directory listing contents, and Integrated View.

Being able to perform customer care-related activities in an isolated manner is not sufficient. CCM 12 characteristics facilitate using the system in a way that meets the requirements of various types of users within an organization that operates in an ever-changing and challenging market. The following are some examples of CCM 12 functionality that illustrate this:

User Interface—CCM 12 provides a set of integrated applications with a consistent GUI which allows users to easily learn how to use the functions.

Scripting—The concept of scripting guides users through regular business processes and thus improves accuracy and completeness of work. Scripts also assist users with recommending product and pricing options that are best suited to a customer's need. Since scripts can be customized quickly, implementing new marketing strategies is facilitated. Scripts define the possible and meaningful screen flows within the new system.

Comments—The text concept allows users to enter free-format information pertaining to an activity. This information then can be used (that is, read and updated) by others.

CCM Benefits

This section contains a number of benefits that a provider will realize from using CCM 12.

Convergent View—CCM 12 provides a complete view of a customer's products, services, and price plans across all markets. It provides users with a complete picture of the customer.

Increased Productivity—CCM 12 provides users with the ability to obtain information in a more efficient manner while assisting them with their daily workflow. For example, this is achieved through the integration of the component with other invention components to provide all customer care information, through automation, and through scripting.

Integrated and Complete View on the Customer—CCM 12 is an integrated module with the other components of the invention. CCM 12 can provide the entire history of the customer from activation through collections.

Reduced Maintenance—CCM 12 provides a sophisticated customer care module that replaces the need for maintaining numerous nonintegrated customer care legacy systems.

Consistent User Interface—The consistent user interface and systems design ensure that users can quickly learn and use the system, as well as easily take on new roles such as supporting new functions in customer care.

Reduced Time-to-Market—The time-to-market is reduced since the flexible structure of the new system allows for new products and customer care strategies to be implemented without coding changes.

Advanced Functionality—Standard and advanced customer care functions are available to support a provider's customer care strategies. CCM 12 provides a powerful search and reporting functions so that the necessary information can be easily obtained.

CCM User Interaction

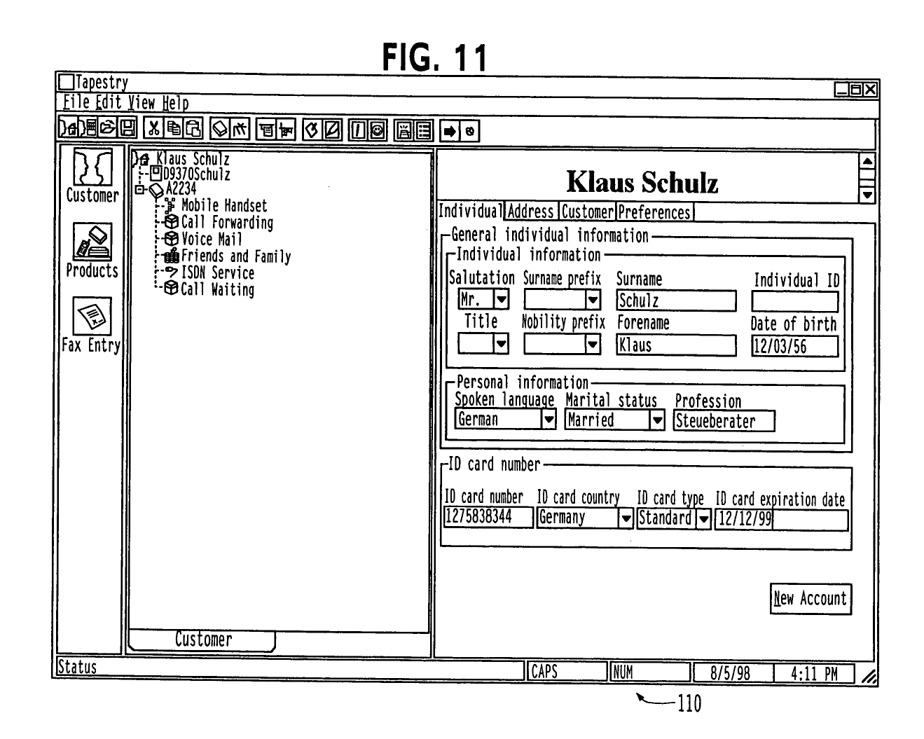

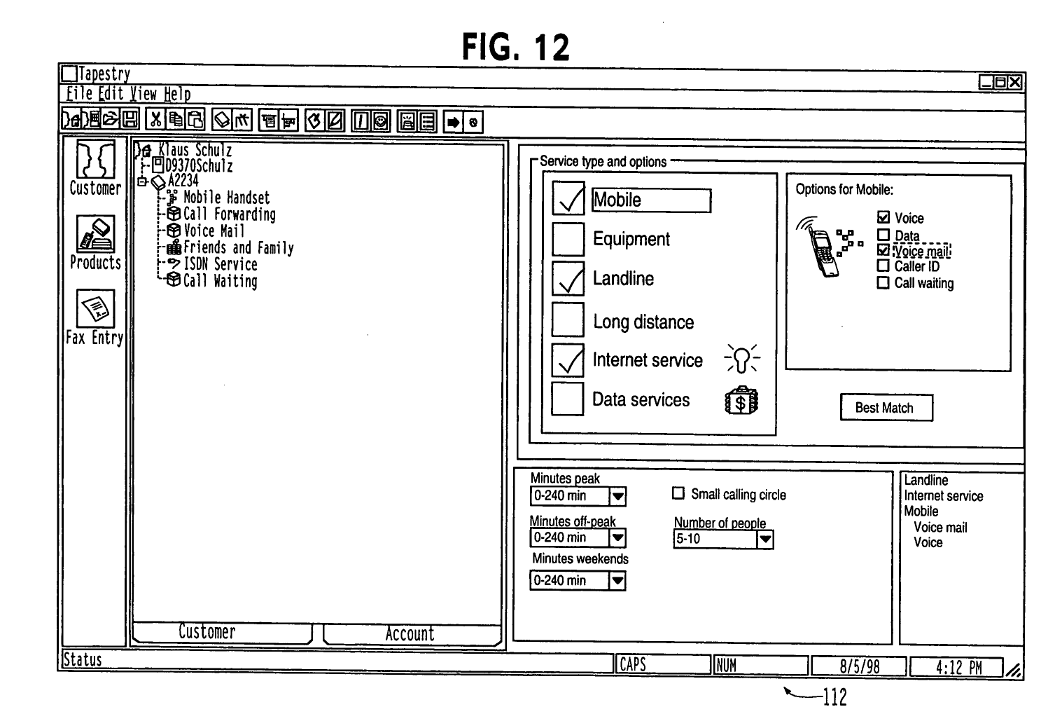

There are two main groups of users for CCM 12: Provider Employees and Provider Customers (via kiosk or remote access). Each of these groups accesses CCM 12 using different technical means. However, since CCM 12—as well as the invention as a whole—is an integrated system with a consistent GUI, all users encounter a similar “look and feel” when they work with CCM 12. FIG. 11 provides an example of a CCM 12 customer screen 110. The screen is used for viewing and updating customer-related information. FIG. 12 provides an example of a CCM 12 product screen 112. The screen shows the user the products and services to which the customer is subscribed and allows the user to add new product and service subscriptions. The view of the customer presented on the screen is convergent, showing all services used by the customer in one view, regardless of the type of service.

Products and Service Manager (PSM)

This section provides a description of the PSM (Product and Services Manager) 14 component of the invention to be used for a provider. PSM 14 stores reference data regarding inventory, products, tariffs, services, and price plans for the system. It has a graphical user interface that allows the user to rapidly define new products and services, and easily maintain the existing products and services.

The graphical user interface of PSM 14 is also used for the Tariff Wizard to be used during the migration to improve the process of creating and maintaining tariff models. The Tariff Wizard will significantly shorten the time that is required for creating and maintaining tariff models.

PSM Functionality

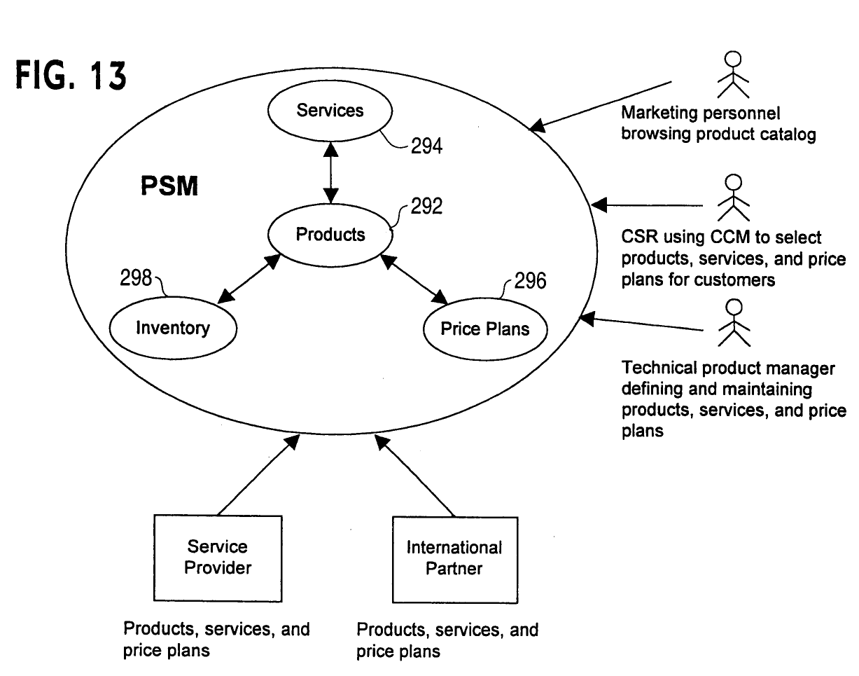

Product and Services Manager (PSM) 14, depicted in FIG. 13, allows an organization to produce and maintain a catalog. A catalog is a container of items available for sale to customers and the mechanisms that allow the organization to charge customers for the purchase and use of those items. These entities include product groups, products, services, pricing structures, and price plans.

Four of the major entities managed by PSM 14 are products 292, services 294, price plans and inventory. To define a product, a product manager defines the basic descriptive details for the product, chooses the services contained by the product, and defines one or more pricing structures for the product. To define a service, a product manager specifies the values of the characteristics of that service, the service level and usage modes, and association rules between the new service and other existing services. Additionally, the product manager specifies tax codes, service categories, and the resource that the service uses. To define a price plan, the product manager specifies descriptive information for the price plan, specifies tariffs and algorithms, defines the conditions for tariff selection, and determines services that qualify for the price plan. PSM 14 also provides a release mechanism to support bringing these entities to market.

PSM 14 provides other applications with items from the catalog. PSM 14 provides a catalog of the items that customers choose from when making a purchase from an organization to Customer Care Management (CCM) 12. Additionally, PSM 14 provides calculation mechanisms used to rate and price events to Event Rating and Pricing (ERP) 16.

PSM Benefits

This section contains a number of benefits that a provider will gain from using PSM 14.

Convergent View of Products and Services—PSM 14 supports the definition of convergent products and services. Wireless and wireline services can be freely packaged together and combined with price plans to create convergent cross-product packages. Different types of charges can be associated with each of the services, for example, installation fees, connection fees, and recurring charges.

Decreased Time for Definition of New Products—PSM 14 has a graphical user interface with which the user can easily define new products and services. The user is supported by conventional wizards in a step-by-step procedure to enter the necessary data. Templates are available that define required information for a particular type of service and provides default values. With the support of PSM 14, it is very easy to rapidly introduce new products and services on the market. This functionality is also used in the Tariff Wizard that will be used during the migration to improve the process of creating and maintaining tariff models. The Tariff Wizard will significantly shorten the time that is required for creating and maintaining tariff models.

Attributes that are specific to a particular type of service can be defined as reference data (for example, the data transmission speed available for a fax service). This information can later be used for display on the bill. PSM 14 also provides a release mechanism to support bringing the new products and services to market.

Simplified Creation and Maintenance of Tariffs and Discounts—Similar to the creation of products and services, GUI wizards support the creation of new tariffs, providing the user with a powerful user interface for tariff definition. For example, the user can define tariff bands in a tariff model by “painting” the bands on an image showing a tariff week.

Updates and introductions of new rates and tariff elements impact reference data only in one place. Because of this and the fact that reference data is stored and processed on the same platform, the effort to test changes to tariff models is reduced dramatically, and hence the time to market for pricing changes significantly reduced.

PSM User Interaction

This section shows some of the PSM graphical user interfaces.

Tariff Zone

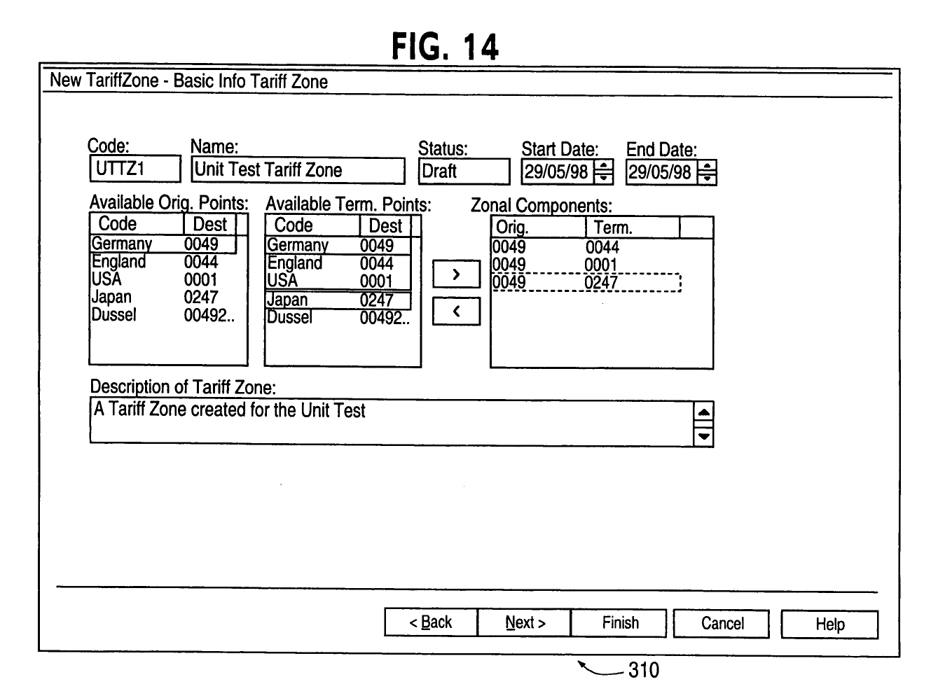

The screen 310 shown in FIG. 14 shows a dialog box that is used when creating tariff zones as part of a wizard used to create new structures for tariffs. The user selects a combination of available originating points and terminating points, and adds them to the list of zonal components by clicking the “Next>” button. As can be seen in FIG. 14, the user can to make multiple selections of terminating points and combine them with an originating point, thereby speeding up the work of defining the tariff structures.

Tariff Week

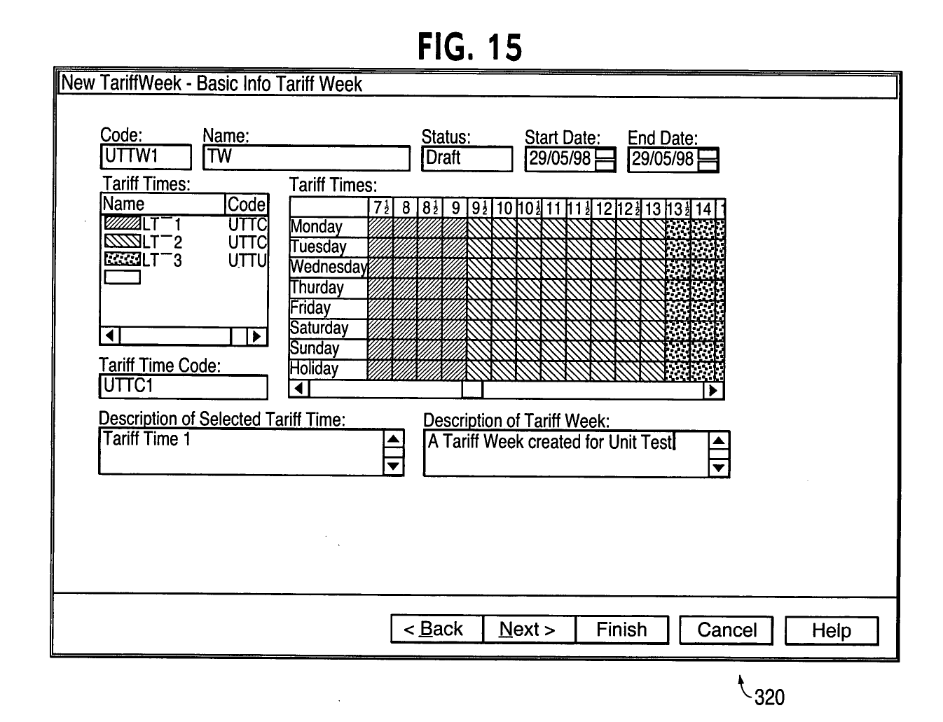

FIG. 15 shows the dialog screen 320 that is used when creating a new tariff week. The user defines the tariff times and “paints” the week in different colors that define the different tariff times using the mouse.

Event Rater and Pricer (ERP)

This section provides an overview of the ERP (Event Rater and Pricer) 16 component of ERP 16 provides convergent real time message processing functionality for a provider's usage and non-usage events based on concepts for handling very large volumes of data ERP 16 accepts and processes network and non-network events to produce bill-ready events (a billable event record that has been completely rated, summarized, processed, discounted and taxed) that can be processed by CBM (Customer Billing Manager) 18. ERP 16 actively collects raw events from different network elements 28 and also processes input from other external entities and other subsystems of the Customer Care and Billing system. The collected events are formatted, validated, assembled and checked for duplicates. After the events are rated and summarized, they are stored in the Billable Event database. ERP 16 also processes recurring and nonrecurring charges, performs taxing, and performs final pricing of the events, for example, volume discounting. The billable events in the database are accessible for billing and can also be retrieved by CCM (Customer Care Manager) 12 and other systems to answer customer queries.

ERP Functionality

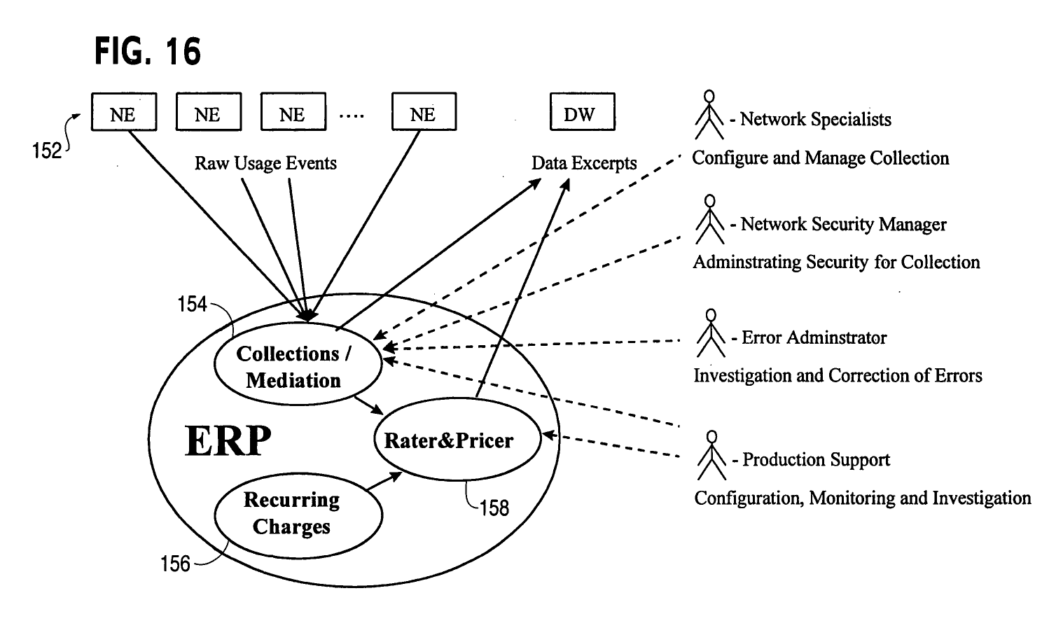

ERP 16, as depicted in FIG. 16, interfaces with various network elements 152 to collect 154 raw usage events. It polls or scans for the pushed information automatically at user-defined intervals and provides the information for further pre-processing and rating. ERP 16 formats the raw usage events into the single internal billing event format, validates the contents and the format of these events, and filters out certain events to prevent them from further processing according to user-defined criteria Furthermore, it performs gap analysis to verify completeness of the received events. ERP 16 also assembles usage events that belong to the same long duration call and filters out duplicate billing events delivered to the system. ERP 16 creates 156 recurring charge events in advance of a bill run to speed up the processing of billing and help customer representatives respond to customer inquiries. ERP 16 further rates 158 billing events according to customer and price plan data, and maintains summaries for certain billing events depending on the specifications in the price plans. Rated billing events and event summaries are then stored for further processing and inquiries. At billing time, ERP 16 performs the final pricing and discounting of usage, recurring charge, and one-time charge events as part of a billing run.

ERP 16 interacts with both external and internal interfaces. It collects raw usage events from different network elements 28. ERP 16 also supports external interfaces to receive events from external carriers and value-added service providers, and internal interfaces to other subsystems for billing events, such as adjustments. In addition to this, ERP 16 interfaces with the Customer Billing Manager (CBM) 18 to provide final pricing and discounting of usage events, recurring and one-time charge events for billing. ERP 16 also interfaces with the Customer Care Manager (CCM) 12 to obtain customer data, the Product and Services Manager (PSM) 14 to obtain price plan reference information, and the Financial Event Engine (FEE) 20 to obtain one-time charges.

ERP Components

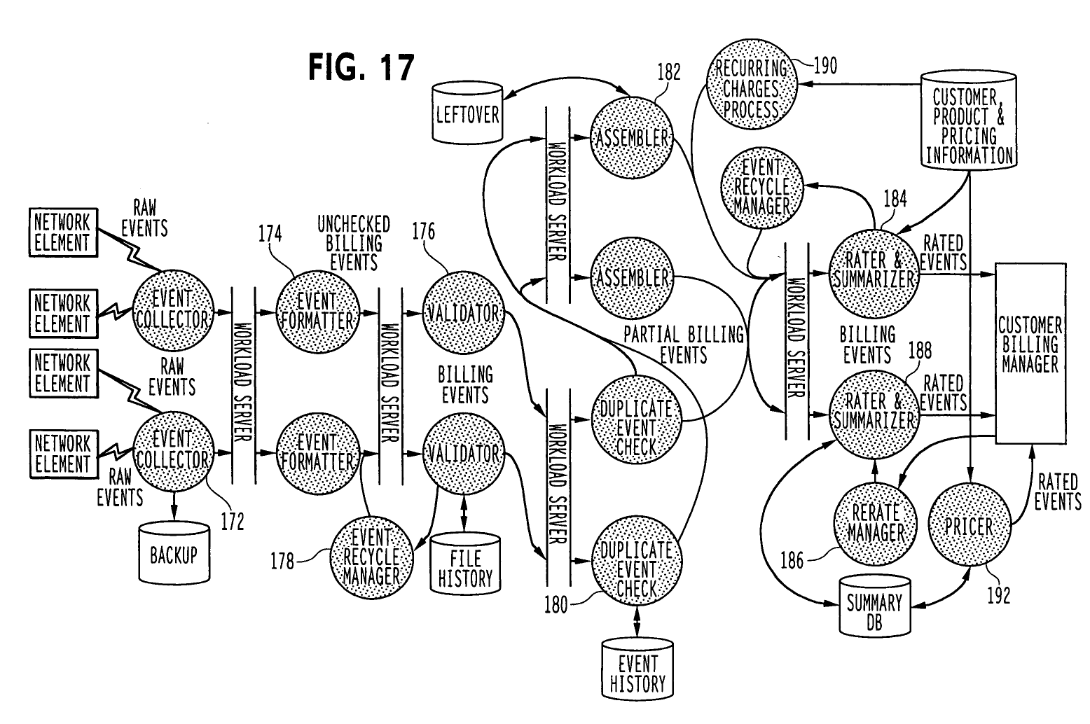

This section gives an overview of the components in ERP 16 and FIG. 17 shows the different components of ERP 16

The Event Collector 172 polls files from the network elements 28 using the FTAM or FTP protocol. The transfer interval for each network element can be individually scheduled by a parameter. Flexible retry functionality is provided in case of unavailable connections to the network element. In case a connection to the network element cannot be established in the first try, parameters specify how often and in which intervals Event Collector should retry to connect to the network element. For data safety the received file is immediately stored in a backup directory. Then a copy of the file is sent to the Event Formatter process 174.

Event Collector 172 reports if a network element does not provide raw event data for a specified amount of time. Parameters specify after which period of time Event Collector should report a warning if no data is received from a network element. The parameters differentiate between workday/weekend and peak/off-peak intervals.

The Event Collector 172 offers a decompression option specified per network element instance. The same concept applies for decryption.

The Event Collector 172 processes can be flexibly distributed on any machine configured with FTAM and external connection (for example, X.25 boards). The Event Collector 172 runs independently from all other processes of ERP 16. This means that any other component of ERP 16 can be started or stopped without impacting the Event Collector 172.

The Event Formatter 174 reformats the raw event format it has received from the Event Collector into an internal format. A raw event record file is rejected if it contains too many erroneous records (where “too many” is specified in a user-defined parameter) or if the reformatter is not able to process it at all, for example, due to corruption. If only some records are rejected due to invalid/unknown fields then the reason is written to the Error Report File, and the rejected records are written to an Invalid Event Records File. For each processed file, statistics are written about the number of records processed, number of errors etc.

The formatted records are written in an internal standardized Unrated Event (UE) format UE records consists of one fixed and one or more variable part(s). After a record is written to the formatted UE file, a message is generated and sent to the Validator 176.

Event Formatter 174 performs record merging for network elements 28 that require this functionality, for example, Nortel DPN 100 and Nortel Passport (X.25, frame relay). Note that this functionality is different than assembly of long-duration calls and is dependent on the type of network element.

The Validator 176 validates the UE (Unrated Event) records for correctness and sends the UE records to the Duplicate Event Check process. Validator 176 performs different types of edits on the fields of the internal record format (for example, numeric checks, date validations, and value checks). Moreover, the Validator determines which records need to be assembled for long duration. An event record file is rejected if it contains too many erroneous records (as specified in a parameter). Single erroneous UE records are errored out and written to an Invalid Event Records File. If some records are rejected due to invalid field contents, the reason is written to an Error File. Each rejected record is prefixed by one or more error codes. Several error groups can be defined. Each record field to be tested belongs to an error group. The importance of the error group determines how to handle the record (for example, ignore the incorrectness, recycle the record, or write it to the Invalid Event Records File). The error severity can be configured. A GUI is also provided for error correction. Corrections can be applied either to individual records, or to multiple records grouped by error codes and error groups. The validated UE records are written to files (different files (same format) for assembly and non-assembly records). For each processed file statistics are written about the number of records processed, number of errors etc.

Event Recycle Manager 178 recycles unprocessed data UE records are written to a Recycle File when some needed reference data is not valid or available. The Recycle File is processed automatically each time new reference data is available. Records stay in a Recycle File for a limited time. The time aspect is related to a user-defined recycle number. If the maximum recycle number is reached, the records are considered aged and are written to the Invalid Event Records File.

Filters can be set up to filter out records. A filter is a user-defined criterion for selecting records based on characteristics of the record. Filters are defined using the ERP graphical user interface. Multiple filters can be combined using Boolean operators to form complex filtering criteria The filtered records are written to a Filtered Records File. Each filtered record is prefixed by one or more reason codes.

Validator also checks for duplicate files. Checks for duplicate records are performed by the Duplicate Event Check process. Additionally, Validator performs an inter- and intra-UE file gap analysis based on the event time aspects. A warning is issued when configurable specified thresholds are passed. The duplicate file check and the gap analysis are performed against the database that contains the keys of the processed files, such as start/end time of the first and last records of each file.

Duplicate Event Check 180 receives data from Validator. Duplicate Event Check checks each single event record against the Event History Database using the key fields of the event records. Each non-duplicate record is written to the Non-Duplicate Events File and the key values are inserted into the Event History Database. Any duplicate event record is written to the Duplicate Events File. When the whole Validated Events File is processed, a message is sent to the Rater and Summarizer, or Assembler that the Non Duplicate Events File is ready for processing. Statistics are recorded in the Process Statistics database, about which file has been processed, how many events in this file had been processed and how many records were filtered out as duplicates. The length of the event history (number of days) in the Event History database is given by a system-wide user-defined parameter value.

Assembler 182 matches various records belonging to the same event for long duration events. Out of various events only one assembled record is generated. The original partial records that are no longer needed in the system are written to a Purged Event File, and remain available for research purposes. The assembled records are written to a file and a message is generated and sent to the next process in the chain.

Incoming records that could not be assembled are written to a Leftover Event File and are matched against later input records. A parameter specifies when records that cannot be assembled because of missing partial records, are aged-out of the Leftover Event File. The aged records are sent to rating if the initial part(s) are available. If the initial part(s) are missing, the records are written to the Aged-out Event File for later research. Moreover, the Assembler also can interpolate missing partial records, if the duration of each partial record is the same (parameter set in the network). Thus a complete call record can be generated even if an intermediate partial record is missing.

Rater and Summarizer 184 receives data from Duplicate Event Check and Assembler. Rater and Summarizer performs the rating of single events and collects statistics in summary records per customer. Rating is based on volume, where volume can be duration, pages, bytes, number of packets, messages, or a number of other units of measure. Volume calculations supported are Initial Unit/Successive Unit rating, Single Unit rating, and Per Event rating. For each single event in the Duplicate Checked Events File, the charges, discounts, and taxes are applied according to the price plan(s) of the customer, who will receive the bill for this event. Tax calculation is based on single tiers per service (for example, there can be one tax rate for voice and another for fax). Rounding is performed on volume and charges according to the criteria specified in reference data Rounding on volume depends on user-defined price plans. The processed event records are written to an output file, the Rated Events File.

Rerate Manager 186 rerates events. Billing can be supplied with Information Events for the purpose of comparing rates/prices from different price plans. Rerating of all unbilled events of one account is supported. Other selection criteria for rerating can also be defined by the user through a graphical user interface.

Promotions are handled via price plans (for example, a customer signing up in January will get a discount of 1% per call. This will be handled via a price plan effective-dated for January). A price plan consists of one or more algorithms. Each algorithm performs one or more volume/price calculations based on user-supplied parameters. The sequence in which algorithms are performed within a price plan, is user-defined. The sequence of calculations within an algorithm is user-defined as well. The parameters (rates, prices, units) needed for volume calculations are defined in Tariff Model Entries. Tariff Model Entries are grouped by Tariff Model Areas. Tariff Model Areas can include a Tariff Week (for example, “Peak” or “Off Peak”) and/or a Zone Coverage/for example, “National”, “Europe”, “Asia”, “USA”, or “Rest of World”) and/or Tiers/Tapers. One calculation takes one Tariff Model Area as a parameter. Tariff Model Entries are created and maintained through a graphical user interface in PSM 14, the Product and Services Manager component of the invention.

Summary statistics are created by totaling single event characteristics at rate time based on requirements of pricing algorithms of the plan(s) for which event is qualified. Summary statistics are updated in the Summary Statistics Database.

Non-recurring charges are supported in the form of non-usage events (for example, an activation fee event is sent by CCM 12 as non-usage event to ERP 16). Summary statistics can be updated accordingly by Rater and Summarizer. The non-usage events are also sent to the Database Event Manager to be inserted into the Event Database.

After Rater and Summarizer 188 processes the Duplicate Checked Events File, there is one output file, the Rated Events File. This file is delivered to the Database Event Manager in CBM 18 for updating the Event Database. Statistics are kept in the Process Statistics database, about which file has been processed, how many events of the input file had been processed and how many records have errored out. Event records, which cannot be processed due to missing reference data or missing customer data, are written to a Recycle File. When updated reference data or customer data is available, the Recycle File is automatically processed. After a user-defined time, older event records in the Recycle File age and are moved to an Aged Out Events File. This process is managed by the Event Recycle Manager.

Recurring Charges Process 190 is triggered by the Pricer Process via a message, when a single account or a whole bill cycle has been prepared for billing. Then the recurring charges events are generated for the next bill cycle. Statistics are kept in the Statistics database about how many customers have been processed and how many recurring charges events have been generated. The recurring charges process also performs prorating and adjustments for activations, deactivations and subscription changes.

Pricer 192 prices events. At bill generation time, Pricer receives a message from CBM 18 to perform final pricing of summary events for a list of accounts. After finishing the pricing Pricer sends a message to CBM 18, that the events are ready for bill production, and a message to the Recurring Charges process to start the generation of recurring charges for the next billing period. Statistics are kept in the Statistics database about how many customers have been processed. Billing can be supplied with informational summary events for the purpose of comparing rates/prices from different price plans. Repricing of unbilled summary events is supported.

ERP Benefits

This section discusses a number of benefits that a provider will realize from using ERP 16.

Convergence_Event Collector can poll Billable Events from different types of network elements 28. Event Formatter and Validator already support a large number of formats, for example, TD17, AMA, and Cisco IP, and can be easily be adapted to support additional formats (also refer to Flexible Definition of Usage Record Formats below).

Flexible Real-Time Rating and Pricing_ERP 16 is designed to handle very large usage volumes and still provide a near-real time rating capability. ERP 16 is based on the High Volume Framework (HVF) which is part of ACL (AMS Class Library). HVF is designed to support large volumes of data in an efficient manner. ERP 16 is designed for parallel processing and the workload is balanced between the different processes by workload servers. Also, ERP 16 is designed to process each Billable Event only once, even for volume discount plans. This is achieved by producing price plan-specific summaries when the Billable Event is processed, and later using the summaries to determine the volume discount. The design is scalable so that ERP 16 can meet the future requirements of a provider.

ERP 16 has been enhanced to include more complex rating and pricing functionality to handle the future requirements of a provider. For example, ERP 16 supports rating and pricing of convergent products and services, associative qualification of charges for price plans (for example, if the amount for international calls during the bill period is higher than a certain amount, a tapered discount is applied to all calls to a certain country) and time allowances (for example, “free minutes”). ERP 16 also allows for the distribution of discounts and charges in a customer hierarchy.

Flexible Definition of Tariff Models and Price Plans—Tariff models and price plans are defined using a graphical user interface in PSM (Product and Services Manager) 14 stores the reference data needed by ERP 16 for products, price plans, and tariff models. For example, the user can define tariff bands in a tariff model by “painting” the bands on an image showing a time schedule. For all work creating new tariff models, the inexperienced user can be supported by wizards (MS Windows help programs that guide the user through a step-by-step procedure).

Flexible Definition of Usage Record Formats—New formats of usage records can easily be added to ERP 16. The record formats and the rules for translating incoming values into a internal standard format are stored in tables and can be easily modified using a graphical user interface of ERP 16.

Graphical User Interface—ERP 16 has an easy-to-use graphical user interface that can be used both for operation of the system and maintenance of the reference data. It is consistent with the GUIs of the other invention components and is based on the same class library (ACL) which allows for a common look and feel across all invention components.

Effective-Dating of Customer and Reference Data—The reference data used by ERP 16, for example, for tariffing and the calculation of price plans, is effective-dated. This means that the data can be entered before it takes effect, and will only be used once it takes effect. For example, if a new tariff model takes effect on Jun. 1, 1999, the data defining the tariff model can be entered today but will not be used for calculations until Jun. 1, 1999.

For ERP 16, each update of customer data in CCM 12 is time-stamped and only the customer data that has been added since the last extract from CCM 12 is extracted for use by ERP 16. The frequency with which CCM 12 is checked for updated customer data is configurable through a user-defined parameter.

Customer Billing Manager (CBM) 18 and Papyrus

CBM 18 is responsible for collecting data, formatting it, and then creating the appropriate documents and output interfaces. CBM 18 refers to both the Billing and Formatting (Papyrus) functionality. CBM 18 supports the production of bills, contracts, dunning letters, balance letters, welcome letters, tariff letters and other reports. All of these outputs are referred to as documents.

CBM 18 may be cycle-driven for which documents are produced at regular intervals, or event-driven for which documents are produced on demand or when a certain threshold has been reached. The only calculations carried out in CBM 18 are summarizing and calculation of totals, other calculations such as pricing and discounting are done in ERP (Event Rater and Pricer) 16.

CBM Functionality

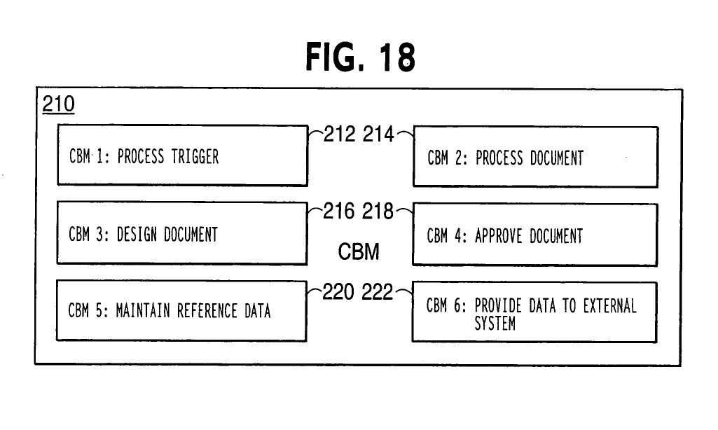

FIG. 18 reflects the functional scope for the CBM application 210. There are six main processes in CBM 18.

Process Trigger 212 initiates the cycle and event based run. In CBM 18, cycles are defined for the different document types (for example, separate cycle for bills, separate cycle for dunning letters, separate cycle for commission letters, etc). Events occur that require documents to be produced, causing the creation of a trigger. Triggers may originate from CCM 12, ERP 16, CBM 18, an external commissioning system, or an external collections system. This could be a trigger to create a contract, a bill, a letter, or a dunning notice.

Process Document 214 includes the processes to collect the document type-specific data. For example, it may be billable events for invoices or balances for dunning letters.

Design Document 216 allows the user to maintain the document template used for the layout of the document and to produce finalized documents ready for distribution to the print vendor. Document templates control the layout of the document and allow users to “customize” the presentation.

Approve Document 218, if required for the documents being produced (for example, invoices but not commission reports), samples from the cycle can be reviewed. Depending on the review result, the cycle can be approved for distribution or rejected to be reprocessed. The documents to sample are based on predefined criteria (for example, all documents with an amount greater than a specified amount). The sample documents can be printed or can be displayed online. The user can then approve the cycle for distribution or reject the cycle for reprocessing.

Maintain Reference Data 220 provides the user with the ability to maintain reference data needed for CBM 18. Reference data allows flexibility for the a provider to tailor CBM 18 to it needs. Reference data includes, but is not limited to, cycle options and rules for bill cycle processing. Separate cycles would be defined for the grouping of documents such as cycles for dunning letters and cycles for commission reports.

Provide Data to External Systems 222 formats and arranges data based on the external entity specifications.

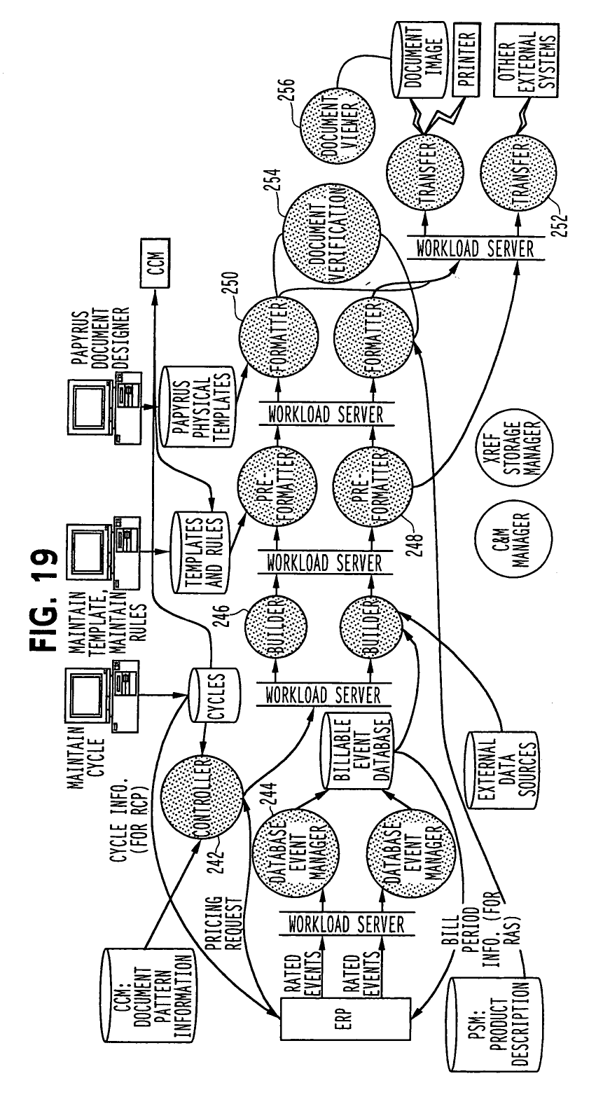

FIG. 19 provides a detailed description of the process flow.

Controller 242 is responsible for the overall control of document production. “Control” refers to starting, halting, re-starting, and monitoring of the CBM 18 process stream from the point when a scheduled cycle is due to start, to the point when CBM 18 distributes the documents produced.

Database Event Manager 244 covers the functionality that allows all event objects to be inserted into the relational Billable Event Database (BEDB), retrieved when required by external entities or other components, and deleted from the BEDB if required. Database event management encompasses the operations and components that surround the BEDB. Database Event Manager has functionality to insert correctly formatted events and error out incorrect events.

Builder's 246 specific responsibility is to retrieve all information needed to produce each document for each customer or account, to collate this information by customer or account, and to present this information to Pre-Formatter for further processing. Builder obtains data from BEDB or another source (external data, such as a collections or commissioning system) as needed to produce the documents.

Pre-Formatter 248 is responsible for converting document objects provided by the Builder into ASCII files. This conversion is driven by Pre-Formatting Rules. The resulting output is either sent to the CBM 18 Formatter (Papyrus, in case of AFP print data) or directly to Transfer to send data to external systems.

ISIS Papyrus DocEXEC is a conventional third-party tool used by CBM 18 to format documents (invoices and reports) into AFP. Formatter 250 is responsible for utilizing ISIS Papyrus DocEXEC. Using the input data and a pre-designed document template created using Papyrus Designer, an AFP output is produced.

Transfer 252 is a generic interface which makes it possible to extend it for any kind of interface that needs file pushing functionality and is completely independent of the type or format of the file(s) to be sent. The File Transfer Interface supports different types of communication protocols (FTP, FTAM, etc) to transfer files to the different external entities.

Document Verification 254 is the process by which the quality of expected documents is checked before finalizing the delivery of these documents to the delivery media Selection rules are entered and then used to provide the user with the documents that meet this criteria The user can view the documents online.

Document Viewer 256 is the process to allow retrieval of document images. ISIS Papyrus Viewer will be used to read the AFP files stored in the Document Image database. Utilizing CCM 12 to request an image, ISIS Papyrus Viewer is invoked to retrieve and display the document image. Images to be stored in the Document Image database are determined by the document type and it is user defined as to whether certain documents such as dunning letters are stored in the Object Model.

CBM Benefits

The following is a list of some of the benefits that a provider will realize with CBM 18.

Convergence—Bills for different types of services (for example, wireless, wireline, and value added services), are supported on one bill. By using the pricing and rating functionality in ERP 16, CBM 18 can generate convergent bills containing advanced cross-product discounts. CBM 18 has the capability to support different bill formats, and can provide separate formats for customers who are billed for convergent services.

Enhanced document templates—Papyrus is a tool that provides design functionality for enhanced document templates. It can easily use any kind of input data with any type of structure. Papyrus can support multiple languages and the designer tool includes spell checking and hyphenation in 17 languages. It supports multiple invoice layouts, user defined variables, smart pagination (page m of n), graphical representations (line, box, bar chart, pie chart, etc.) and color printing. In addition, during the document creation process, a format can be previewed and tested before moving into production.

Rapidly define new documents—Papyrus supports a short time-to-market for new document formats. It is easy to learn how to use the design tools in Papyrus. It is estimated that a new design could be created from scratch within two to three days, and a new format based on an existing format could be developed even faster.

Multi-Currency—CBM 18 can support displaying charges in multiple currencies, for example, Canadian or US dollars.

Bill Verification—CBM 18 supports advanced functionality for viewing a selection of bills before they are printed. CBM 18 provides the ability for the user to pre-define selection criteria for which documents should be verified and displays the document as it would be printed and sent to the customer.

Performance—By utilizing modern technology and an advanced architecture, CBM 18 is capable of producing very large volumes of bills, supporting both the current a provider requirements, and providing a robust solution for the future.

Messages on the bill—With CBM 18, rules can be defined to determine which customers get which messages and the priority of which messages to use. These messages can be used to provide selected customer segments with promotional information.

Quality Assurance—CBM 18 includes a control process, which monitors the bill day process. In addition, statistic reports are available for providing quality assurance on information from the cycle run.

Bill Image—To meet legal requirements, Papyrus ensures that the exact image of the bill sent to the customer is stored and can later be retrieved using CCM 12, for example, to answer customer queries.

Flexible Bill Periods—CBM 18 provides flexibility in the definition of bill cycles. A bill cycle can be defined in any increment, from days up to years, and bill cycles can be executed both on a periodic basis and on demand.

On Demand bills—CBM 18 supports the creation of on-demand bills. An on-demand bill includes all charges that have been processed by ERP 16, that is, both usage and non-usage charges. On-demand bills can, for example, be used to provide the customer with an initial bill directly when the customer is activated, or for a final bill directly after disconnection.

CBM User Interaction

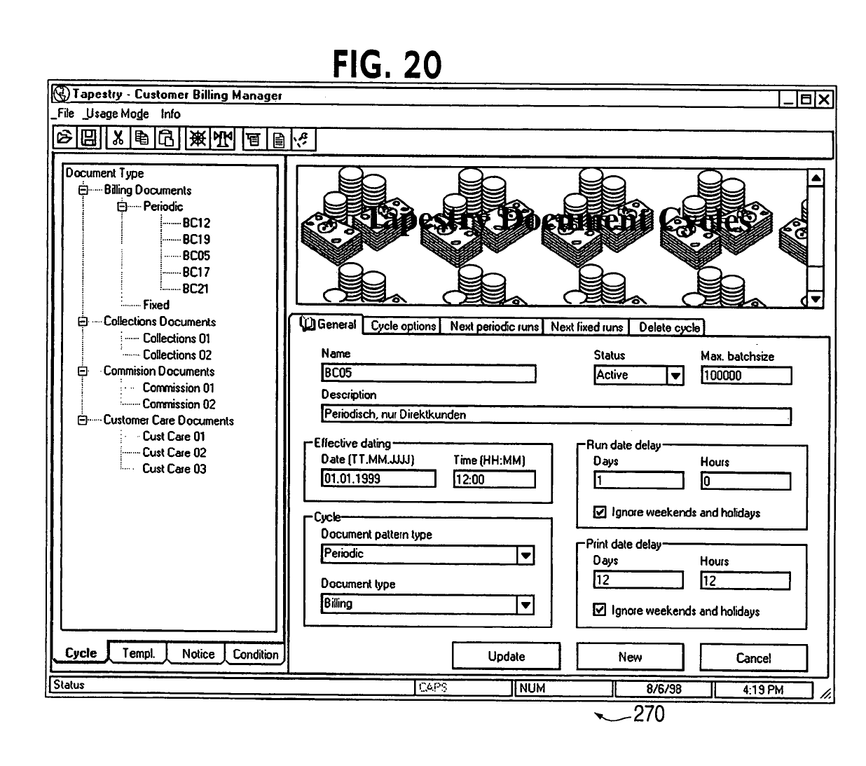

This section shows some of the CBM graphical user interfaces. The GUIs in CBM 18 are mainly used to maintain reference data such as bill cycles. FIG. 20 provides general cycle information screen. FIG. 21 shows a Papyrus screen from Papyrus Designer, which is used to create new document templates. Several windows are open which show the document and the definitions.

Order Processing (OP) 22

OP 22 provides active order processing, order management and service activation across a convergent platform. It includes workflow, workforce management, scheduler and service activation. OP 22 accepts requests for work as input. This work request is analyzed to determine if the request can be fulfilled automatically (e.g. an activation of an Internet account for a residential customer, or a feature—e.g. “call waiting”), or if fulfillment of the order needs to involve workforce. Service activation or deactivation tasks are translated into network commands for direct communication with the appropriate network elements 28. If an order requires workforce intervention, the OP subsystem retrieves the scheduling template (which can be thought of as the “best case” project plan, which would be realistic if all resources were available when needed), and activates the scheduler. The scheduler accesses workforce availability and modifies the “best case” plan into a “realistic’ plan. This includes taking into account all scheduling dependencies that are required. The result is a workflow, identifying the proper order in which tasks must be completed, the estimated time required to perform a task, and the type of resource required for each task. OP 22 actively monitors each task, generating alarms for potential error conditions, such as tasks failing to start or finish at their scheduled time. OP 22 completely automates order scheduling and processing. This eliminates time-consuming errors due to missed steps and improper work implementations, freeing valuable resources to perform other value-added functions.

OP Functionality

FIG. 22 shows the functional areas and components in OP 22. The following describes each of the eleven areas and components for OP 22 as depicted in FIG. 22.

CCM Interface—The CCM interface 143 provides the functionality to receive orders, retrieve additional order information, and update the order status and subscription information.

PSM Interface—The PSM interface 144 provides functionality to retrieve service, service characteristic, and product information from the Product and Service Manager (PSM) 14.

State Transition Knowledge Base—The State Transition Knowledge Base or engine 145 approves or rejects the state transition requests (cancellation or orders, completion of tasks, starting of tasks, etc.), starts automatic tasks, validates the structure of the workflow, monitors the state of the internal order and each service request within the internal order.

Order Builder—The order builder 146 generates the structure of an internal order from a customer order and a set of service requests. A set of business rules are used to ensure that the correct work flows are selected for each service, and that the appropriate management levels are added within the order.

Order Management—The order management 147 contains all of the base functionality used by the Order Builder, State Transition Knowledge Base, and Planning Engine. This base functionality includes the abilities to: display a users work queue, modify a workflow structure, submit a workflow to the planning engine, forward calls to the State Transition Knowledge Base (the user does not interact directly with the State Transition Knowledge Base), modify/display documents, and modify/display provisioning characteristics of the service request.

Workflow Templates—The workflow template 148 provide the functionality to define workflow templates, task templates, and selection rules for work flows. The order builder selects and instantiates workflow templates when a service order is received in a customer order using the selection rules.

Service Activation Controller (SAC) 142 acts as a mediator between the workflow engine to the Service Activation Software (SAS) 150. For each service request SAC 142 decides to which SAS 150 system the request is directed, translates the request into a format understood by the SAS 150 and forwards the request. In the current implementation, SAC supports the CORBA interface to Architel's ASAP product, send/receive ASCII files to the IP-SAM system, generation of LCRS ASCII files, and generation of generic ASCII files. Other service activation software (3^{rd} party or AMS developed) could be easily “plugged” to this mediator.

Service Activation Software (SAS) 150 is the interface to the network elements 28 and is responsible for all updates from network sources. SAS 150 recognizes update requests, determines the network element 28 that should be updated (switch, router or other service system), formats the request into the proper format (e.g. Man to Machine Language (MML) or CISCO protocol), and issues the request. If the link to the network is down, SAS 150 will continue to re-send the request until the link is restored. Examples of SAS 150 systems are American Management Systems (AMS) Network Access Manager, ASAP from Architel or IP-SAM from Arcor.

Planning Engine—The planning engine 146 plans individual orders and optimizes all orders within the system against the available resource requirements. The planning engine makes use of ILOG Solver/Scheduling to perform this planning. In the planning phase, previously designed standard work flows may be selected by the system or customized by a project manager for each service request. System defaults for resources and dates can be accepted or overridden during the process of creating a workflow for the internal order. During the planning of an order, capacity and usage information related to resource pools are automatically updated in order to facilitate resource leveling and capacity planning. The planning engine supports scheduling based on parameters. Utilization percentage as well as “backward planning” are supported. A user can specify that e.g. 70% of workforce only should be used for installations. A user can specify overtime, e.g. 110% of workforce should be used. Alternatively a user can ask the system to compute how much capacity is needed to meet all of the commitments (backward scheduling against given dates). The planning engine further supports geographically distributed workforces. It is possible to move resources from one workforce to another to smooth “peaks and valleys” in scheduling demand.

Calendar—The calendar 151 contains the functionality to capture workforce assignment rules to various resource pools, and to calculate the available capacity for all resource pool. The calculation of available capacity is used in the scheduling engine to perform task scheduling.

Workforce—The workforce 149 contains all of the base functionality used by the order builder, calendar area, order management, workflow template and planning areas. This base functionality includes the abilities to: define workforce resources, roles, regional locations and resource pools within the system.

OP Benefits

This section contains a number of benefits that a provider will realize from using OP 22.

Convergent View—OP 22 provides a complete view of all service requests, regardless of their associated market. Customers can place a single service request with both wireline and wireless subscription changes.

Increased Productivity—OP 22 alleviates the manual task of scheduling service requests, determining resource availability, and monitoring open service requests. Provider personnel can concentrate on activities requiring human involvement.

Advanced Scheduling Algorithms—OP 22 supports all types of standard scheduling algorithms. Task dependencies, service request dependencies, and resource availability are all taken into account during the scheduling process.

Active Monitoring—OP 22 actively monitors service requests until their completion. Not only does OP 22 ensure that subsequent tasks are initiated at the proper times, it ensures that any deviation to schedule are immediately reported through alarms to the appropriate supervisor and dependent tasks not started. The invention maintains two conditions of tasks: at-risk and late. At risk tasks are in danger of being late, while late tasks have no chance to be completed on time. The invention monitors tasks for these conditions and creates alarms that are directed to workers to inform them of the problems.

Complex Costs—Costs allow the telecommunications provider to track the cost of providing a service to a customer. Estimated, actual, and forecasted costs are maintained by OP 22.

Integrated Resource Reservations—OP 22 is designed as a complete solution. To be a complete scheduling system, OP 22 must be able to interact with a workforce and materials management system to verify availability. Since OP 22 does not include materials management, the invention provides an interface to external systems to provide this functionality.

Workflow and Follow-Up Functionality—The workflow and follow-up related functionality adds an important dimension to customer care activities. With OP 22, the efficiency of interactions within the provider's organization can be increased significantly. Examples which highlight these features are:

Information about certain activities can be forwarded to other departments or people using free format memos.

Requests to perform certain activities (like a follow-up call some time in the future) can be entered and addressed to a suitable role or person. Depending on the context, suggestions for possible follow-ups are made.

Technical Description

In Data Processing there are four metrics, which describe the difficulty and therefore the costs of running a system:

Volume of data to be processed and number of transactions performing the work.

Growth of data volume and transaction volume.

Frequency of software changes.

Availability requirements

In an increasingly competitive marketplace, a telecommunications provider is positioned within the area of most difficulty as quantified by the previous metrics. A provider's successful business strategy has led to a system whose size and growth presents technical challenges due to both volume and subscriber growth.

Frequent software changes necessary to bring new products to the market place lead to both organizational challenges, as parallel changes to the same part of the application are impossible, and software which is increasingly complex and requires ever larger hardware resources. Additionally, integration of third-party packages often require extensive changes in base software in order to successfully integrate them.

Finally, as the availability requirements of a customer care and billing system increase, the ability of the production department to meet these goals decreases. More effort is diverted from availability management and funneled into solving the problems caused by increasing volumes and rapid development cycles in large areas of the key application.

The invention software architecture is designed to maximize new functionality development speed. The invention improves time-to-market due to the following:

Modular System

Due to the modular nature of the system, components communicate with each other over well-defined interfaces. A change in one module, which does not affect the interfaces of this module, will not affect other parts of the system. This greatly reduces the analysis effort required when implementing new functionality.

Object Orientation

The object oriented design and development methodologies used in the invention increase the speed at which new functionality can be developed and improves maintainability of the developed software. Application developers can concentrate on adding additional functionality to the system rather than having to continuously reinvent the wheel. This compartmentalization of business functionality also is an enabler of parallel development as it significantly reduces the likelihood of parallel running development projects modifying the same part of the application code.

Use of Frameworks

Application developers are supported in the development effort by the use of frameworks. These frameworks provide a support layer to the developer and provide a base upon which business functionality can be developed. This concentrates development resource on the provision of business functionality, rather than solving technical difficulties.

Thin Client Architecture

Frequently, in the rapid moving world of telecommunications, it is necessary to implement the same business functionality for multiple end users. Thus, the functionality to change from one tariff to another would be implemented multiple times in a legacy system (e.g., on-line screen for customer service representative, interface to voice response unit for self-service over the telephone network, and interface to a web browser for self-service over the Internet).

The invention solution allows this business functionality to be implemented once within application server, and re-used by any multitude of clients.

Scalability of Application both in On-Line and Batch Environments

In legacy systems, considerable development effort is invested to overcome technical hardware and software limitations. This effort costs time within the development department and hinders the rapid introduction of new products and services. The invention architecture is designed to be scalable at both the application and database server level. Bottlenecks can be overcome by adding additional hardware rather than time consuming application code changes.

In the batch environment, the invention provides the stream I/O concept where classic batch processing such as billing is broken up into more manageable units and these units are then automatically processed in parallel. Opening up additional processing streams can provide additional capacity with work being automatically distributed over available processing steams. These additional processing streams can be freely distributed on any available application server maximizing the utilization of available hardware resources,

In the on-line environment, the invention provides two processing models to deal with the challenges of scalability. For simple interactive processing, stateless servers are used. This maximizes application availability and throughput as requests from the GUI can be routed to any available server.

As not all on-line workload is created equal, the invention also provides a framework for application servers, which are used for complex interactive processing. This minimizes the overhead required as objects are built only once on a server, rather than being built for every transaction.

Ease of Integration Through Open Event Driven Application Architecture

Although it is important to have a system that can be easily changed, it is equally important to enable integration of third-party solutions (e.g., financial processing, such as SAP or Oracle Financials). As intelligent network (IN) solutions become functionally richer and more robust it is important to be able to easily integrate these solutions into a customer care and billing system. Many legacy systems have difficulty supporting functionally rich interfaces. The effort required to integrate the third-party solution equals and sometimes exceeds the effort necessary to directly implement the solution within the system.

The Event Collector 172, a sub-process of ERP 16, together with the event driven architecture, acts as an intelligent interface able to encapsulate the often-complicated functionality required by IN technologies and act as an intelligent mediator between the other system modules and the IN system itself. This application architecture provides maximum reuse of existing system application components and prevents IN mediation rules from having to be implemented in the heart of the system. The results of this approach are lower development costs and easier integration of IN functionality.

Enterprise Ready System Management Architecture

Although the implementation of additional functionality represents a significant part of the cost of running a customer care and billing system, an often-overlooked cost is that of running the system in a production environment. In the rush to the client/server world where hardware and license fees are reduced in comparison with a mainframe environment, many firms forget the necessity of a system management architecture providing the automation of the operational environment. This often leads to disappointment as the wins gained in the increased flexibility and responsiveness of the development department and the scalability of the application are often countered by the increased operational costs due to the increased necessity for personnel. These operational costs are often of significance particularly in a maturing mobile market where it becomes increasingly important to reduce the costs of each additional subscriber.

The architecture contains an enterprise ready system management architecture. This allows for automation of boundary conditions and the automatic handling of situations in an operational environment. This allows for the automation of the operational environment, reducing operational costs and preventing the necessity for large numbers of additional staff.

Technical Application Structure

This section presents the overall software structure. It describes the architecture of on-line and batch software processes and explains some operational features of the system.

Software Architecture

The invention software provides a consistent, object-oriented, and fully client/server architecture which satisfy will a provider's business requirements. The architecture is:

Open: The invention preferably runs under UNIX and uses Oracle, an industry-standard relational database. However, it is not operating system or database dependent, and could easily be adapted to run e.g. on NT instead of Unix or on Sybase instead of Oracle. Furthermore, technical features of both products (and other third-party products used in the AMS Class Library frameworks) are encapsulated to the highest extent possible consistent with achieving high-performance processing.

Interoperable with other systems: the system has a clearly defined concept for componentization, allowing a provider the freedom to add new subsystems based on the same architecture, remove and replace components within the invention without replacing the whole, and interface the invention in a straightforward way to other systems.

Distributed and adhering to industry standards: The invention uses CORBA and message queuing for middleware, which supports network-wide communications on top of TCP/IP.

Scalable and high-performance: the platform designed to support volumes in excess of those proposed in a provider's requirements without requiring fundamental changes to the architecture.

Flexible for future extension and enhancement: The invention is object-oriented, which allows encapsulation of details that are likely to change over time. Object-oriented features like inheritance and polymorphism allow reuse of common domain objects to provide related functionality (e.g., deriving new objects from existing ones to support additional types of network events as they are made available on the network).

Manageable: the software contains integrated support for control and management. The application-knowledgeable aspects of system management are handed within the AMS Class Library (ACL) Control and Management framework. Other aspects of system management (e.g., backup, disk, system, and database monitoring, can be performed using a third-party product of a provider's choice).

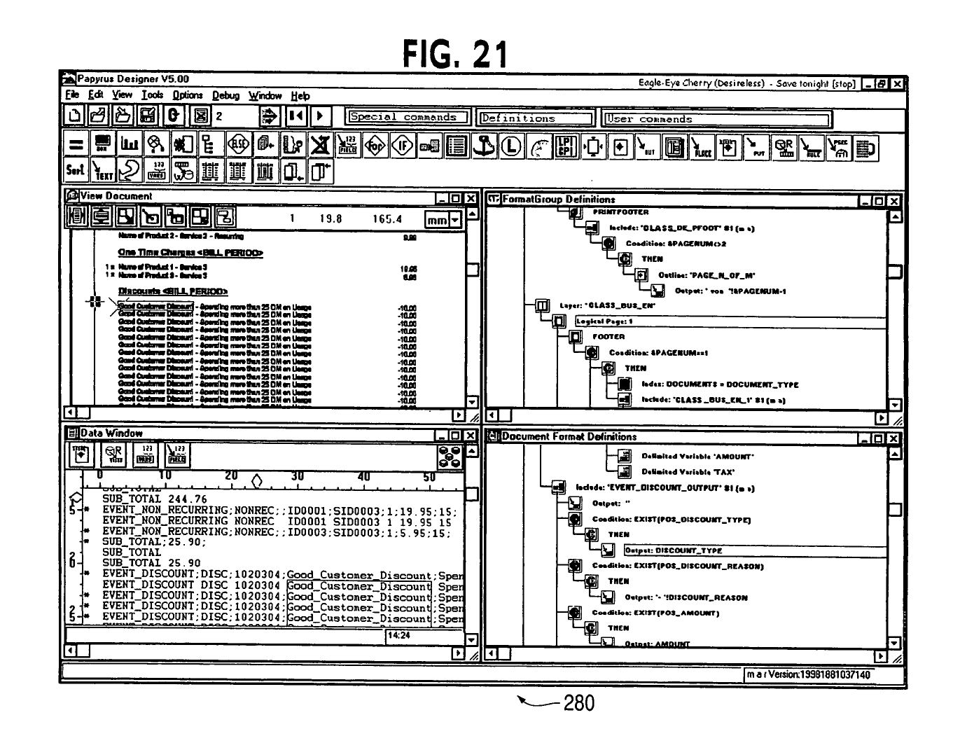

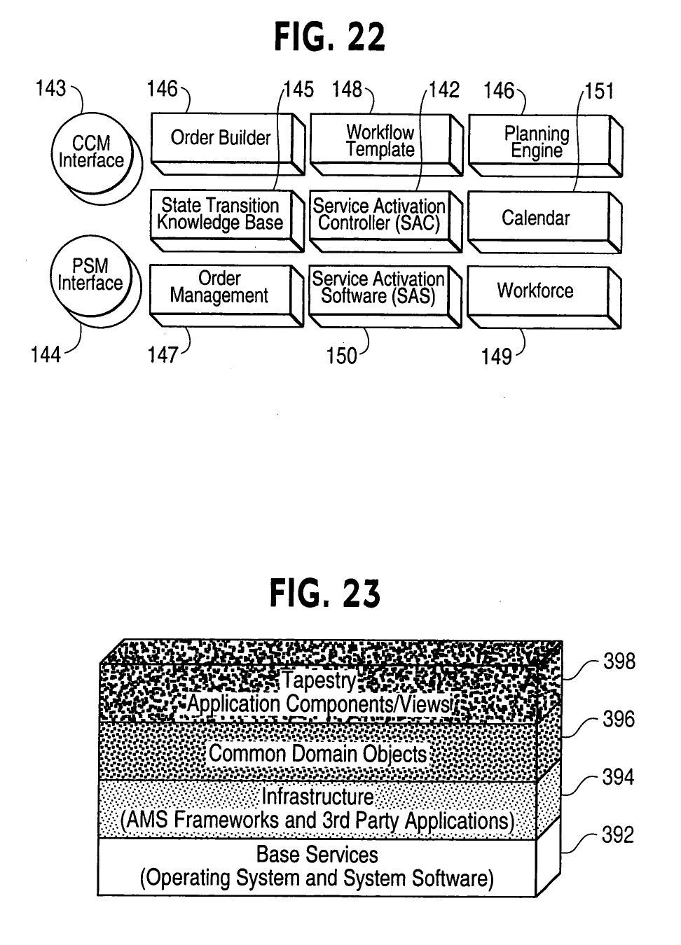

The invention application contains software layers that encapsulate different aspects of processing. The layers are illustrated in FIG. 23.

In going from the bottom of the diagram in FIG. 23 to the top, classes progress from generality to specificity. At each level, the functions are used to support processing that is resident in higher layers.

The lowest layer 392 is provided by third-party products, including base software supplied by hardware vendors (e.g., server and network operating system, database management system).

The infrastructure layer 394 contains two types of software: Frameworks that focus primarily on application support (e.g., base classes for common process structure and services); and Third-party or conventional application products that offer “black box” functionality or are class libraries that are integrated into the applications.

The frameworks in the infrastructure layer are described in the Component Model section. The infrastructure layer encapsulates the functions provided by operating system services so that conversion from one vendor to another is isolated from business applications. The infrastructure layer contains class libraries from third-party vendors (e.g., Rogue Wave, Isis, ILOG) that can be used directly by domain objects.

Common domain objects 396 are more functional objects that can be used in more than one place by the business application layers. An example of a common domain object would be the base CdoEvent class used to represent network events within the invention. Different types of events (e.g., Voice, SMS, ISDN, telephony, long-distance, Internet) are derived from a generic domain object. Common domain objects encapsulate behavior that is telecom-specific.

The invention is built from components that have clearly defined interfaces with each other. The application components 398 included are CCM (Customer Care Manager 12, OP (Order Processing) 22, ERP (Event Rating and Pricing) 16, CBM (Customer Billing Manager) 18 and PSM (Product and Service Manager) 14. These five component packages and their application views (i.e., user interfaces) are combined with interfaces to other provider applications and external partner systems to make up the full system.

Standard Software Layers and Associated Tools

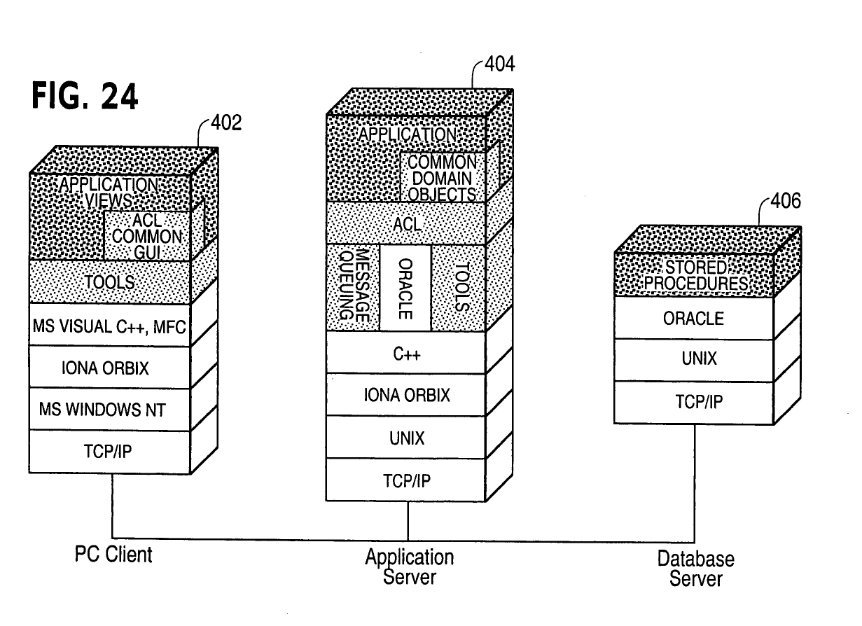

The software architecture is integrated as depicted in FIG. 24. The software is preferably implemented in a client server arrangement application server 404 which obtains information from a database server 406. The system also includes storage, such as disc or RAM, for storing the processes of the invention as well as upon which the processes can be distributed. The processes can also be distributed over a network, such as the Internet. All software of the invention uses a consistent set of tools and frameworks, and follows the same standards. This uniformity is extended to cover third-party software incorporated in the invention where possible.

The table below describes the software found in the layered software diagrams:

TABLE 2
Standard Software in Tapestry layered software

| Layer | Description |
|---|---|
| ACL | A Class Library which provides infrastructure |
| | support for server-based processing. |
| ACL Common GUI | ACL classes that provide infrastructure support on |
| | a PC client. |
| Application | The server-based application software. This layer |
| | includes the implementation of the business objects |
| | defined in the object model designs. |
| Application View | That part of the on-line application software that |
| | provides a user interface. |
| Common Domain | These objects provide common classes that can be |
| Objects | leveraged in different parts of the application to |
| | provide support for common services and functions. |
| C++ | C++ programming language. |
| Iona Orbix | CORBA 2.0 Object Request Broker (ORB) |
| Message Queuing | This provides guaranteed delivery for messages sent |
| | between processes. |
| MS Visual C++, | Microsoft C++ compiler and Microsoft Foundation |
| MFC | Class libraries. |
| Oracle | Oracle client and server software. |
| Stored Procedures | Application-specific Oracle stored procedures. |
| TCP/IP | Network communication protocol. |
| Tools | On servers, this includes third-party products like |
| | Rogue Wave Tools, h++ and ILOG class libraries |
| | that are integrated into the software, as well as |
| | “black box” components like ISIS Papyrus that |
| | provide standalone application services. On a PC |
| | client, this covers products from Sting Ray (e.g., |
| | Objective Toolkit grid controls). |

On-line Software Architecture

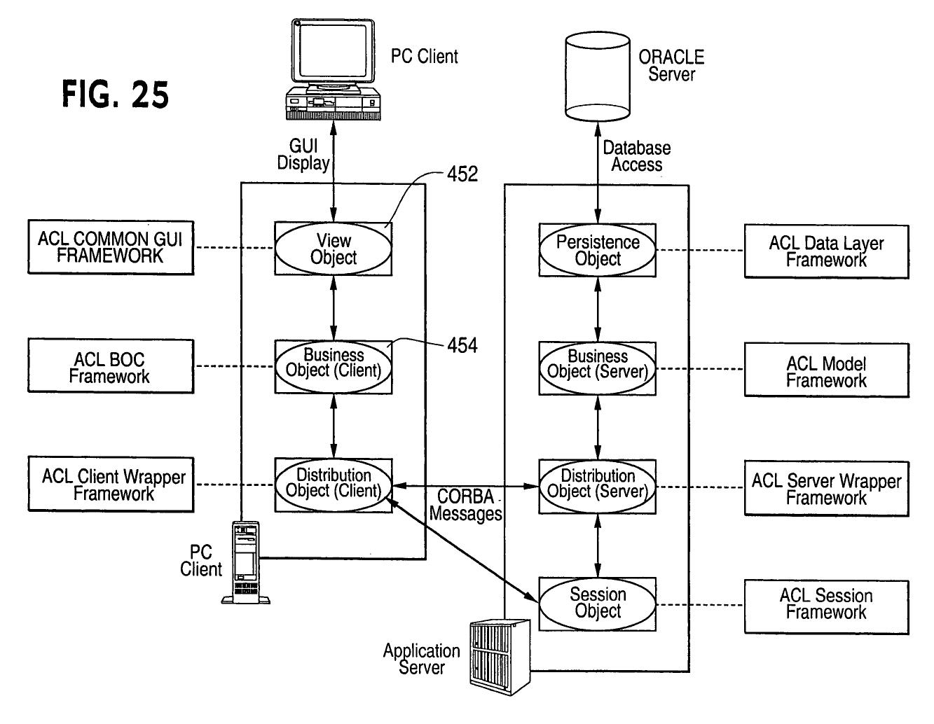

The infrastructure layer needed to construct interactive applications is shared with batch and stream I/O processing. On-line processing is very different than batch processing, due to PC-based GUI clients and the short and time critical nature of interactive transactions. Security concerns are also greater in the on-line arena (see the Security Approach section). FIG. 25 shows the frameworks involved in on-line processing. The diagram shows the major types of objects and infrastructure frameworks involved in executing an on-line function. A transaction will generally involve one or more than one of each type of object. The process begins with view objects. These objects are derived from AMS-built classes that are, in turn, derived from the Microsoft Foundation Class (MFC) library. This wrapping is performed to standardize the look-and-feel of the GUI, make it comply with the system GUI standards, and simplify the process of developing applications. The view objects implement the window behavior defined in the interaction model.

The views communicate with proxy business objects on the PC client. These objects correspond one-to-one to the business objects on the server that implement the real business behavior. The business objects on the client (BOCs) contain the same methods as their server counterparts. The most important ones are “validate” and the methods needed to store persistent data. When a BOC method is called, the distribution mechanism causes the method call to be sent to the server, where it is executed by the “real” business object on the server. The result of the call is sent back to the client object.

The Distribution Layer has Several Important Capabilities

A client wrapper object can be instantiated on a server. This allows the creation of n-tier client/server applications.

The code for the distribution layer is generic. Only the names of the objects, method calls, and parameters change from one transaction to another. As a result, the code for both the client and server wrapper objects will be generated from metadata provided by a programmer. This approach reduces errors and enhances development productivity.

Using code generation for the distribution layer also encapsulates the type and vendor of middleware in the system. A provider can then enhance or replace this layer if a different approach is desired in the future.

The encapsulation of the distribution layer enables the consistent creation of transaction performance statistics from within the application. This provides high quality data needed for the analysis of performance problems within a high volume production environment.

The distributed method calls are synchronous. They must complete before the user is allowed to perform another action in their Windows session. The distributed method calls in the invention are passed to-and-from client to server via character streams. This optimizes performance since the use of Interface Definition Language (IDL) for all calls would otherwise add overhead to each transaction. Because the method calls are created from a code generation template, a different template could be used to generate IDL interfaces instead of having fully CORBA-compliant interfaces. A third type of template could be used to generate C language APIs. This gives complete flexibility in making server functions available to other client processes besides the GUI.

Business logic is performed on the server model objects. A number of models are combined together to make up an application server process. All of the models that a user may access during an application session will be contained in the same server. When a GUI user logs in, the infrastructure creates an object in the session layer, which ties the client to a specific server process (although this can be overridden to force a model to a different server process). A user may have more than one active session at the same time (i.e., when more than one GUI application is “launched”). Neither session will have knowledge of the other.

On-line application servers are multi-threaded. Allocation of connections between the client and the application server is performed using a random workload distribution algorithm with guiding rules within the infrastructure allowing for differentiation between stateless and state-full servers.

Most application servers are stateless; however, for certain complex business transactions, it is necessary to store state information within a server and create an affinity between an application front end and an application server. In order to prevent end users having to wait for application servers blocked by long running transactions, stateless transactions are distributed randomly across a pool of applications servers reserved only for short-running stateless transactions. Long running transactions, which require preservation of state information, are allocated to a user for the duration of the transaction. The control of the association between the GUI and an application server is the responsibility of the invention infrastructure.

The persistence layer is used to store and retrieve object-related information within a relational database. The Data Design and Management section discusses translation of object-data in the physical database model to relational tables (i.e., via hierarchical, expanded, or compressed mapping). Each server model object is related to one or more tables that contain the object's data attributes.

In the usual case, a model object's data is stored as a single row in a relational table. The primary key on the table is the object ID. The server model object is associated with a set of objects, one for the table (known as a row factory), one for the row, and one for a collection of rows. The row factory object contains the SQL needed to perform database access. It uses the row and row collection objects to maintain the data that is retrieved or is used to perform updates. The information contained in row objects is accessible via getter and setter methods from the model (and by distribution) from the business object on the client. In fact, for high speed access of data by the client (e.g., for doing searches to populate list box views), the row collection can be streamed directly from the factory on the server to a row collection on the PC associated with the client business object.

In the case of a hierarchical or expanded storage scenario, the data for an object may be stored in more than one table. This is a consequence of the design of the object. For example, both a Residential Customer object and Corporate Customer object may be derived from the same base Customer class. The implementation of the data model for Residential Customer may involve two tables, one table for the part of the data that is common to both types of customers (i.e., the attributes in the base Customer class) and another for the attributes that are specific to a residential customer. This hierarchical representation is not visible to the server model object. The model (and by extension, the GUI client) accesses the object as if it was contained within one database row. The persistence layer hides the hierarchical (or compressed or expanded) nature of the database implementation.

Each object in the invention databases have a unique identifier (ID) associated with it. This ID may be system-generated and have no business meaning, or it may be constructed of one or more application-related attributes (possibly concatenated with a system-generated key for uniqueness). The choice of identifier for an object is governed by the following rules.

If an object has a natural business-related identifier, it will be used unless the ID is subject to normal change during the life of the system. For example, a Service object should not have an ID that is a phone number, even if all services must have a phone number when they are set up. This is a poor choice because the phone number assigned to a service can be changed upon request of the customer. It must be possible to track the old and new versions of the Service object using the same ID.

Extremely large tables or tables with high-volume updates should preferably have application-related identifiers. This is because a system-generated ID will require a separate database access index. The number of indexes has a significant performance impact.

In cases where an identifier must be created for business purposes (e.g., an Account ID that will be communicated to the customer), this should be done in a way that ensures uniqueness and is understandable at the same time. Two different identifiers will not be created.

The infrastructure layer for persistence also provides the following support.

Heterogeneous collections. Some object model relationships involve collections of objects of different types). The persistence layer allows the creation of heterogeneous collections through polymorphic queries.

Polymorphic queries. A single model method call may create a collection of heterogeneous objects. Inplementation of this involves appending lists of objects of each type that are individually retrieved from corresponding row factories.

Inheritance. If a hierarchy of model objects is derived from a common base class, their associated row factories can derive from each other as well. This guarantees consistency in the implementation of inherited classes.

Access by foreign key relationships. While most retrievals on objects are via the primary object ID, many objects will have to support multiple access keys. This is accomplished by adding additional access methods to the row factories.

The streaming of object collections from server-to-client uses infrastructure support for a process called “chunking’. To avoid extremely long response time for transferring large collections, only a part of the collection is sent in one method call. The number of objects in one chunk is configurable for each transaction that uses chunking. The GUI can get better response time by making multiple calls to get all data needed by a user. In many cases, only the first chunk of data needs to be retrieved.

Most business-related objects in the database are effective-dated. This means that more than one row may be stored for each object. Each row has the same “nominal” object key and a different effective date. The effective date is used to determine the time frame for which the row is valid (i.e., represents the state of the object). When an object is retrieved from a relational database a date must be passed so that the correct row data is returned.

Server processes perform all database access. If a client needs data, it must get it by invoking a method on a server object. Any access to a database must be performed through a database “connection.” The infrastructure manages connections within the server process. All objects accessed within a session use the same database connection to guarantee that they participate in the same database transactions. Different GUI clients that share the same server process will use different database connections.

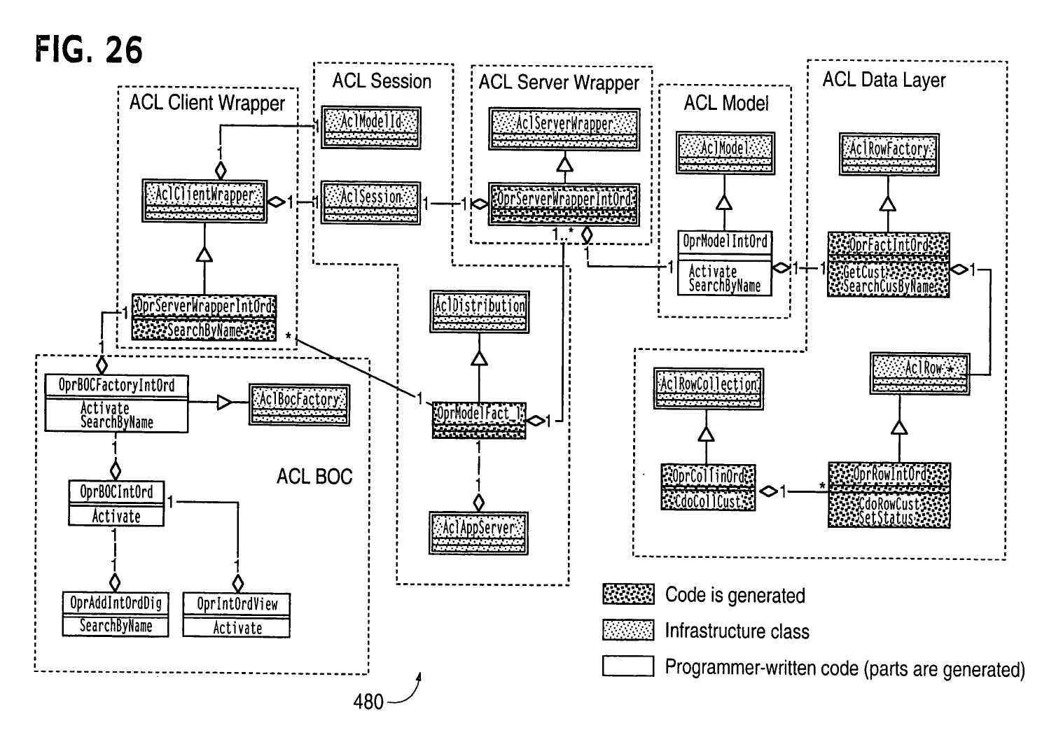

As a final point, the code in the persistence layer, like the distribution layer, is highly standardized. The implementation of the row factories, and row collection objects reflect a small number of design patterns. As a result, the majority of this code will be generated from metadata FIG. 26 shows a sample object model 480 that illustrates the different types of objects involved in a real client/server transaction. Pieces of virtually all non-infrastructure objects are produced through code generation. The ones that are entirely generated are shown.

Batch and Stream I/O Software Architecture

The remainder of the software is built upon the same infrastructure foundation as the on-line processes. The parts of the invention that operate without direct user interaction are called “batch” and “stream I/O”. Batch units of workload are initiated periodically, usually according to a pre-defined time schedule or by predictable arrival of an occasional event or file of events from an external system. Examples are the creation of an interface file for an off-line system like the data warehouse or creation of a daily report. Stream I/O events occur more unpredictably, often in almost continuous fashion. The processing in this part of the invention is optimized for high-volume performance. Processing of events within the Event Rater and Pricer (ERP) 16 subsystem of the invention is an example. Messages are rated as soon as they are made available to the invention. The Customer Billing Manager (CBM) 18 application component is the other part of the invention that is a heavy user of the batch and stream I/O processing model. Additional information about the processing mechanisms of batch and stream I/O processing (e.g., division of input into “units of work”) and the scalability of the processing environment are described in the Transaction Management/Concurrency Handling and Scalability Approach sections.

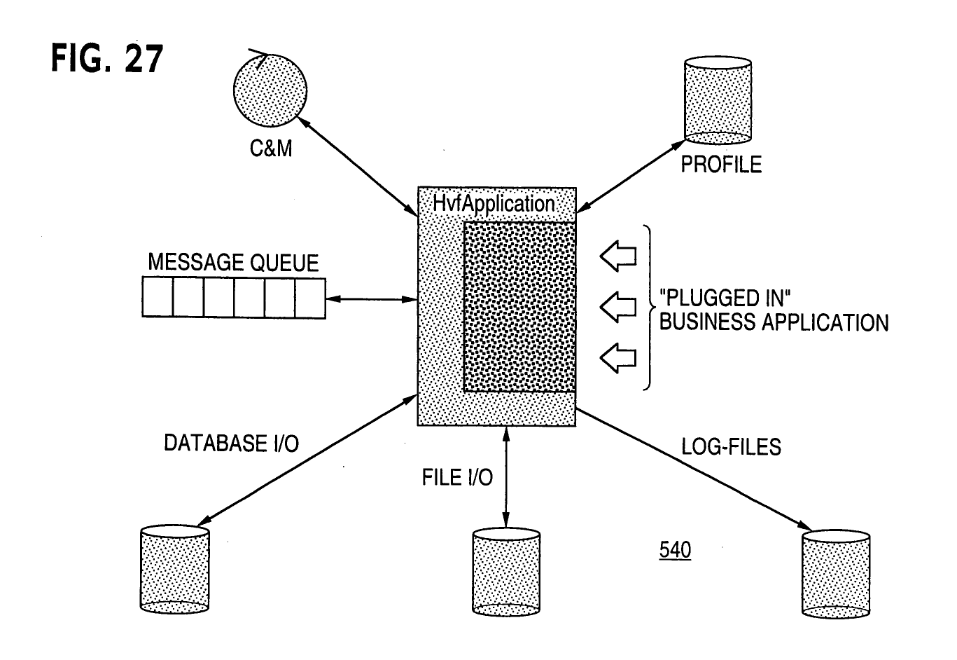

The structure of a general batch or stream I/O process 540 is illustrated in FIG. 27. Each batch process inherits from the HvfApplication infrastructure class, which provides a context for handling event-based processing. All batch and stream I/O processing is initiated in response to messages received in the input queue of the process. This is accomplished by coding a method Process Message that provides application-specific handling of asynchronous input queue messages. There are two types of messages that can be received: work messages and control messages. Work messages identify the location of the next “unit of work’ to be processed—usually a file of input records (e.g., serialized input event objects). Control messages are higher priority than work messages and are read first Examples of control messages are requests to shutdown or turn on a trace feature used for debugging. On completion of processing, a queue message is written to the next process downstream in a chain of processes.

What about the first process in the chain? How does it receive its work instructions? There is a special control message that is sent at the time of process initialization called an “idle” message. This allows the initial process to begin processing without receiving a work message. For example, the ERP Collections process interprets its startup idle message as a sign that the infrastructure has been initialized and that it is OK to start retrieving events from a network element.

The infrastructure creates a number of objects that provide services to the application during run time. One example is the Profile object. It retrieves parameter information from a hierarchy of files. A global profile contains values that apply to all processes (e.g., queue system parameters). Specific parameters applicable to all processes of a particular type (e.g., all ERP Validation processes) and to individual processes (e.g., the fourth instance of Validation) are read from other files. Another example is the Logger object. It is used to log run-time information to general and detailed log files on the server.

The Component Model section provides additional information on the infrastructure services available to batch and stream I/O processing.

System Management Architecture

A systems management architecture is required to run the systems. This technology is well documented in the software world and a person skilled in the art would be knowledgeable in this technology.

Network Architecture

This section briefly describes the protocols and middleware components used for communication between the various clients and servers in the invention.

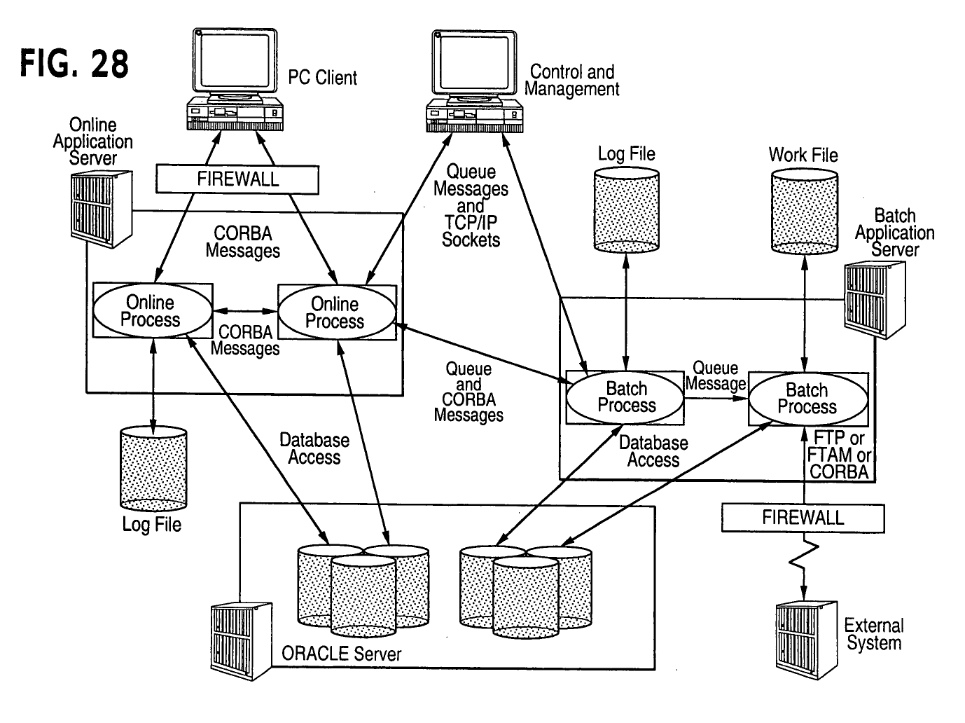

FIG. 28 shows the major types of inter-process and data access communications that occur within the invention. Each is discussed in more detail below:

PC Client to On-line Application Server: This communication is performed using Iona Orbix as middleware. Orbix is a CORBA 2.0-compliant Object Request Broker (ORB) which implements distributed object access across a user network. Orbix runs over TCP/IP.

On-line Process to On-line Process: Objects in different on-line server processes may also communicate with each other using CORBA.

Batch Process to Batch Process: Predecessor and successor batch processes communicate with each other through file-based queue messages. This custom facility uses files to contain messages. These messages are guaranteed to be delivered regardless of the state of the receiving process. The message cannot go away until it has been physically read and “confirmed” by the receiver. Since this mechanism is file-based, it uses normal UNIX file access.

On-line/Batch Process to Batch/On-line Process: Intercommunication between batch and on-line processes may be accomplished by either CORBA or file-based message queuing depending on the situation. In general, synchronous communications will be performed using CORBA and asynchronous communications will use file-based message queuing.

On-line/Batch Process to Work/Log File: All server processes write summary and detailed information to log files. Batch processes also write data to work files. Both types of files may reside in a file system mounted locally to the server, or they may be accessed via NFS.

On-line/Batch Process to database server: The invention processes access the relational database via SQL*Net (which runs over TCP/IP).

Control and Management to On-line/Batch Process: The Control and Management component of the invention sends commands to processes running on application servers using file-based queue messages. TCP/IP sockets are used to send information to the operations monitor display.

On-line/Batch Process to External System: Communication between the invention and external systems (e.g., SAP; Data Warehouse, IN Network, etc.) are handled via various interface-specific protocols. Different mechanisms are used at both the application level (e.g., FTAM, FTP for file transfer) and at the physical level (e.g., switch-specific protocols) depending on the communications supported by the external system and the characteristics of the interface. All communication to external systems (with the exception of non-TCP/IP links like FTAM) may have to pass through firewalls to restrict unauthorized access.

Component Model

The invention software is built from multiple components, including frameworks, tools, and applications provided by the invention and third-party providers. Frameworks are groupings of reusable, modifiable objects and services that, when used together, provide structure for building applications. Frameworks combine both white box (i.e., require developers to internals understanding) and black box (i.e., can be used with less knowledge) object classes. Tools aid in the overall development and testing of application software. Applications perform business and user-specific functionality.

This section describes the frameworks and tools that make up the Infrastructure layer of the invention. It briefly describes the capabilities and use of each of the software components, which are integrated into the invention. The focus of this section is on the AMS-developed components. Detailed information about third-party frameworks may be obtained from the respective vendor.

The various components that make up the Infrastructure layer are shown in FIG. 23. Note that, although certain products are associated with specific components, they can be used more generally (e.g., ISIS Papyrus is used by CBM 18 and could be called by another part of the invention if required).

All the frameworks used for the invention development are packaged within the AMS Class Library (ACL). ACL includes reusable components, many of which are proven from use in other systems. ACL is organized into:

ACL High Volume Framework (HVF): provides basic high-volume services that are needed by all applications;

ACL On-line: provides classes for building and distributing server-based on-line applications; and

ACL Common GUI: provides classes to support GUI PC client-based applications.

ACL High Volume Framework (HVF)

Particular services provided by HVF to support client/server processing are discussed below.

Error Handling: Error handling allows applications to deal consistently with error or fault situations. Error handling for batch applications is different in some respects than for on-line applications since high-volume errors must not stop processing as long as work can continue. On-line errors generally must be dealt with immediately. Even so, many of the functions needed for error handling are common (e.g., logging, retrieval of message text). Refer to the System Error Handling section for more information on error handling.

Process Control: This service allows processes to be controlled by a central control and management process (C&M). In this case, C&M can start, stop (gracefully or immediately) and monitor processes to verify their current state (running or in error). Most of process control and management is transparent to the application layer. It is encapsulated at a lower level within ACL.

Message Queuing: The message queuing mechanism allows processes to communicate asynchronously with each other. Processes can send messages into one or more output queues. The output queue is then read by a process, which is attached to the queue. Using special workload balancing processes, message queuing provides a straightforward mechanism for load balancing across multiple batch application processes serving the same function.

The message queuing service is extensively used by the batch applications to transfer information about files to be processed between processes.

Profiles: The profile service allows configuration of processes using initialization files stored in text format. Long-running background batch processes can use profile services to re-read specific settings whenever a new unit of work is processed. This will ensure that the most recent values are always used.

Cross Reference Data (XREF): The XREF service reads data from files or from the database and makes it available in a read-only form to processes via memory mapped files. Memory access significantly increases performance of processes, which rely extensively on reference data. XREF transforms the data maintained by one application into data read by another application. Using XREF reduces dependencies between application components since otherwise they must directly access each other's data across separately coded software interfaces. For example, the ERP Rate and Summarize process accesses customer data owned by CCM 12 through the generic XREF interface instead of using a more specialized access mechanism.

Runtime Performance Measurement and Reporting: Using this service, batch applications can send runtime information to Process Control and Management display (e.g., the number of processed records in a unit of work). On-line response time measured by a client process can be captured and stored by a server process.

C++ Regression Testing Framework (CRTF): The CRTF service is used to write self-testing objects. Unit tests can be regressively invoked in a rapid and easy manner whenever modifications and improvements are made in application code.

ACL On-line

ACL On-line provides basic services for writing interactive server applications running on back-end application servers. It includes a distribution mechanism that enables C++ method calls from client processes located anywhere on the network. ACL on-line services also translate object-oriented data in server programs so that it can be stored in the relational model used by the Oracle database. ACL On-line also supplies the services needed by on-line applications to ensure optimum process concurrency and restart ability. The functioning of these services is further explained in the Transaction Management/Concurrency section. Particular services provided by ACL On-line are described below.

Application Servers: ACL Core provides the framework to build application servers that answer and process client requests for transactions in a multi-tiered environment. The communication between the application server and the client is encapsulated via Orbix mechanisms. The application servers contain the business logic of an on-line application and communicate with the database as needed. Thus, the business logic and database access is separated from GUI clients and network traffic is reduced.

Distribution Mechanism: The distribution mechanism of ACL allows the GUI application code to communicate with objects on servers as if they are local objects. The distribution of an object's services using Orbix is transparent to the GUI. The application code does not know where server functions reside on the network. Using this layer, clients can create and destroy objects on the application server and can use only public interfaces to objects on the server.

Persistence: The database persistence layer of ACL provides an interface between object-oriented application data and the relational database. For objects, which need to be persistent, ACL provides a code generator which generates object-specific persistence method calls and implementations. For example, ACL automatically generates the code needed to create, update, select, and delete a customer object using only metadata describing the information that must be transferred to the database.

Security Maintenance: This framework provides the necessary elements to maintain and use the security mechanisms of the invention. It includes login screens for each application component and supplies windows to maintain controlled users (i.e., principals) and their profiles. A description of the security architecture can be found in the Security Approach section. Details about the implementation of Security Maintenance are contained in the detailed designs of the common services related to security.

ACL Common GUI

ACL Common GUI provides functionality for the PC client processes to display the various elements of GUI screens like windows, tree control hierarchies, and buttons. This allows the creation of GUI screens with a common look and feel across application functions and components. ACL Common GUI wraps Microsoft Foundation Classes and the more specialized Sting Ray classes, which include grid controls, specialized edit boxes, and others.

Frameworks from Third-Party Vendors

Several third-party software libraries and applications are integrated into the invention. Some of them like ILOG libraries and, ISIS Papyrus are specific for application components. Others, like Rogue Wave Tools.h++ are used by all application components.

ISIS Papyrus: This package is used for CBM 18 bill formatting. The invention uses the tools Papyrus Designer to layout document designs and define processing instructions, and Papyrus DocExec to create formatted documents.

RogueWave Tools.h++: This class library supplies object classes that supplement and extend the types provided in standard C++. Within the invention, its primary use is for dates and times.

ILOG: For server based work-flow AMS uses third-party libraries from ILOG. These class libraries (ILOG Solver, ILOG Rules, and ILOG Scheduler ) are used by OP 22 to implement rule based server side workflow. ILOG Solver and ILOG Scheduler will be used to handle the planning of the activities in the system, especially scheduling of order-processing related tasks.

Data Design and Management

This section covers both the methodological and the technical approach for designing and managing data Individual functional components will use the approach described here in their designs. In addition, the overall data management task will use this approach to define standards and guidelines for the use of data.

For persistent object storage, the invention uses either files (e.g., event files in ERP 16) or a relational database. The different techniques to map objects into these non-object oriented storage types are described.

Integration of the Invention with a Relational Database

For a relational database like Oracle, there are three strategies by which objects can be mapped to a relational database.

Hierarchical Model: One-to-one mapping of objects to tables.

Expanded model: A one(parent object)-to-many(child object types) relationship is mapped to many tables. Each table contains the attributes of the parent together with the attributes of one type of child object. There is one table for each type of child object.

Compressed model: The relationship goes into one (denormalized) table. In the compressed model, all attributes for the parent object and all child objects are stored together in one table.

Defined naming standards and mapping guidelines for objects and database tables are used to track which objects and attributes are mapped to which tables and columns at any time, and vice-versa A simple example is the Customer object, which is mapped to the Customer table. The customer attribute Status is mapped to the Customer table column called Status. Integration of Invention Application Data with Flat File Storage and Memory Access

The invention Serializer performs the transfer of objects to and from the system using flat files. A Serializer simply streams attributes of objects from memory to a disk file or from a file to memory. The Serializer framework contains a base class that is used by several specialized derived classes, which are designed to handle different objects to be streamed. The Serialize class also offers methods to determine how many objects have been read or written and to handle input/output (e.g., open, close, read, write, append, overwrite). The streaming operator supports all standard types of C++ used in the invention.

Besides the mechanism described above, there is a need in the invention to install database-resident data in application memory so that batch and on-line processes can access it efficiently. For these types of mappings, a process called XSM (XREF Storage Manager) is used. XREF (or cross-reference) data includes price plans, products, customer, and other reference data that are maintained in database tables by the CCM (Customer Care Manager) 12 and PSM (Product & Services Manager) 14 components of the invention. Processes like the ERP 16 Rater and Summarizer as well as the Pricer need this data to be in memory for high-performance operations on network events. Retrieving the data from a database for each single event would slow down event record processing in an unacceptable way.

To increase look-up performance, XSM data is stored in memory-mapped flat files. These files (known as XREF files) are loaded into memory by the batch applications as the data are accessed. Multiple processes can share memory-mapped files. If two processes on the same machine map to the same file, the file will be loaded into memory only once.

The XREF Storage Manager is the interface between the databases and the XREF files. This process is responsible for maintaining both the master XREF files and incremental update files. Each master file is initially a full download extract of a database table. Over time the master file will get out of synchronization with the database because of database inserts, updates or deletions that are applied to the database table. For large tables supporting time-critical functionality, these additional changes are captured periodically and made available to running processes in an incremental update file.

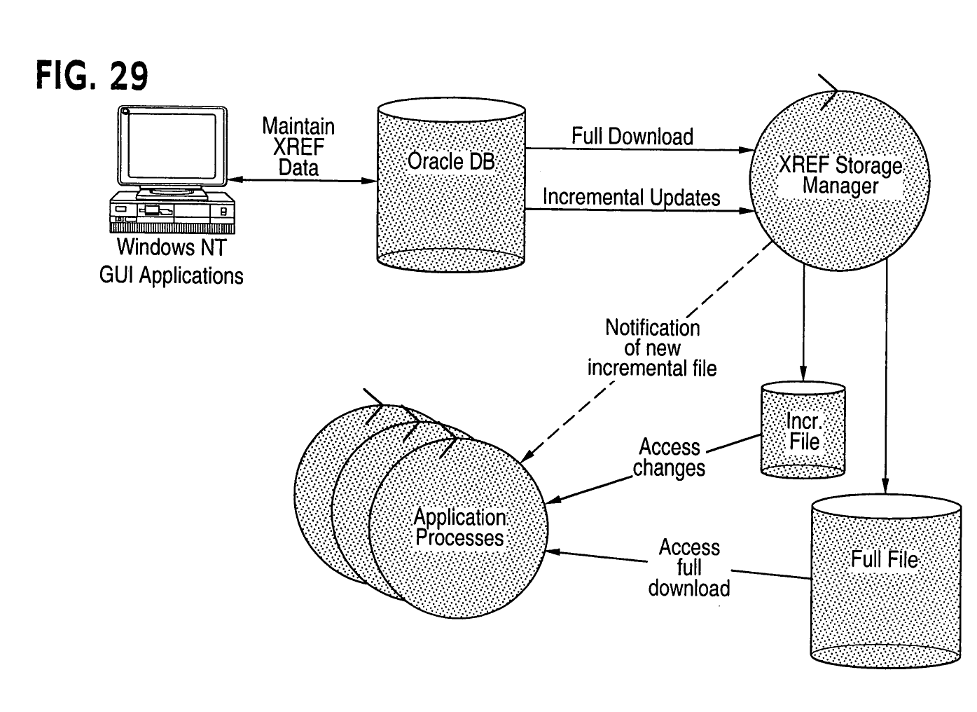

Applications use the High Volume Framework of ACL to access XREF files. The framework merges master and incremental update files into a consistent, consolidated table representation for the application. Running processes also receive messages from the XREF Storage Manager that indicate when new incremental update data is available for use. FIG. 29 illustrates the XREF data maintenance and access mechanism.

Data and Application Distribution

This section describes the basic rules that application processing and data access must follow to support distribution across multiple component applications, database servers, and computing platforms. The discussion in this section is high-level and focuses on data distribution and interfaces between applications. Application process distribution is covered in detail in the Technical Application Structure and Scalability Approach sections. The rules are followed, where practical, for third-party software applications integrated into the invention.

General Rules

All data is “owned” by components. The invention system involves the co-operative processing of different application components, including CBM 18, ERP 16, PSM 14, CCM 12 and FEE 20. All data in the system is owned by one and only one component application. Where data is shared by more than one component, the application that creates or maintains it is generally assigned ownership.

Data access is controlled by the component that owns it. If one application component needs to read or update information that belongs to another, it generally do so through an interface provided by the other system. This guarantees that data configuration is locally encapsulated within a single component. Structural changes in the storage of data within one component does not generally require corresponding changes in other components unless there is an inherited change in an interface between them.

Data access is restricted to the invention processing. The databases should not be used for ad hoc queries or support direct access by external systems. This lessens coupling of data between the invention and other systems. It also avoids imposing uncontrolled or unrestricted loads that will impact the invention response. Data mining and other intensive, non-time critical reporting will be the responsibility of the Data Warehouse system. Interfaces will supply information to other systems. To avoid placing significant load on the invention, data will be copied/replicated into separate interface files or databases.

Data is stored and managed by server processes only. No customer data is stored locally by a PC client process. This guarantees data manageability, integrity, and security since databases can only be updated after appropriate editing and security checks are performed on servers. Critical enterprise data is also easier to backup/restore and protect if it is not distributed to the user desktop.

Data Distribution

The object data will use two types of persistent data storage. Data that does not need to support concurrent access (e.g., is used exclusively by high-volume batch processing, not the on-line system) will be kept in standard UNIX files. Information maintained by interactive users is stored in the database. As examples, the intermediate events involved in processing steps within the Event Rater and Pricer (ERP) 16 component are stored in simple UNIX files (at the end of ERP 16 they are stored in the billable event database). Customer information is stored in a relational database.

File System Storage

Only two processes typically access the data within batch files, the first one creates it and the second receives it as input for the next step of processing in a chain of process steps. The passing of a file between processes guided by a control message indicating the name of the file. The location of these files is configurable using initialization parameters so that both processes and data files can reside on separate hardware platforms. For best performance, it is desirable that the work files used by a process be stored on disks that are local to the CPU running the processing. However this is not always possible, since computers will fail and processing then needs to be restarted on other hardware. The invention does not restrict the location of files with respect to processes. One of the key configuration parameters that must be addressed to set up the running system is to determine the number of UNIX file systems needed and determine the distribution of files across them.

Relational Database Storage

For data stored in databases, the situation is more complex. Each application component that uses the relational database can access the data that it owns in a separate database running on a dedicated server. Within some components, more than one database/server is possible. This modular design will allow for multiple separate data stores for example ERP has Duplicate Check and Billable Events.

In some of these cases, a database can be further split (e.g., separate Duplicate Check databases for groups of physical network elements 28, or a partitioned Billable Event database using the mechanism presented in the Scalability Approach section). In practice, however, it will be desirable to combine many of these databases, especially the smaller ones. Complexity of the invention operation will also go up as more databases are involved. This configurability is not completely transparent, but because interfaces are encapsulated in clearly defined objects, it is possible to switch from one mode of operation to another without re-architecture of the invention system.

The key features which differentiate the invention from past and existing products are:

Convergence—Convergence enables the invention to be the single customer care and billing system for any service provider, such as telecommunications. All services can be defined and offered to customers, regardless of line of business: wireline, wireless, Internet, cable, or entertainment. All services are maintained in a single customer database, proving a single customer view to CSRs. All of the services can be brought together into a single pricing plan to promote volume discounts across services. A single bill can be created which depicts all charges for these services, including cross-service discounting. The key here is that the bill is truly converged, not simply produced by consolidating the output of multiple systems (also known as “consolidated billing” or “electronic stapling”).

Modularity—The invention is a set of individual (integrated) modules that can be implemented individually or in combination. This modular approach was taken to address provider need. Each provider will have unique requirements for a solution. Some will require a complete make-over, while others require update of only a portion of their existing processes. The invention's modular design enables each component to be sold separately to meet each provider's needs. The cost of a large-scale billing system can be prohibitive to some providers.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art it is not desired to limit the invention to the exact construction and operation illustrated and described, and accordingly all suitable modifications and equivalents may be resorted to, falling within the scope of the invention.

1. A method, comprising:
collecting events from a plurality of service systems;
rating and pricing the events; and
producing a consolidated bill for a customer subscribing to a plurality of services.

2. A method as recited in claim 1, further comprising providing an integrated view of the customer data, billing data, product data and services.

3. A computer readable storage for controlling a computer via a process of collecting events from a plurality of service systems, rating and pricing the events; and producing a consolidated bill for a customer subscribing to a plurality of services.

4. A method, comprising:
providing a collection of convergent products providing distinct and independent services, each having different event collection and service systems;
collecting events from a plurality of said service systems providing a collection of heterogeneous usage events;
converting said events into a common formatted usage event;
rating, pricing, discounting, summarizing and billing said usage events based on said event collection system including cross discounting across the converged products; and
producing a consolidated bill for a customer subscribing to said convergent products.
